(19) United States
(12) Patent Application Publication
(10) Pub. No.: US 2025/0135604 A1
(43) Pub. Date: May 1, 2025

(54) HORIZONTAL CLAMPING SYSTEM

(71) Applicant: Machina Labs, Inc., Chatsworth, CA (US)

(72) Inventor: Aaron David Keit, Simi Valley, CA (US)

(21) Appl. No.: 18/931,362

(22) Filed: Oct. 30, 2024

Related U.S. Application Data
(60) Provisional application No. 63/594,922, filed on Oct. 31, 2023.

(51) Int. Cl. B25B 5/00

(52) U.S. Cl. CPC B25B 5/003

(57) ABSTRACT

A clamping system may include a bottom clamp bar with a top surface configured to interface with the sheet to be held. The clamping system may include top clamp bars adjacent to each other and arranged along a portion of the bottom clamp bar, the top clamp bars having bottom surfaces configured to interface with the sheet to be held. The clamping system may include screws that pass through holes in the top clamp bars and holes in the bottom clamp bar. The clamping system may include pins coupled to bottom surfaces of the top clamp bars or top surfaces of the bottom clamp bar, the pins forming pivot points for bottom surfaces of the top clamp bars to pivot toward or away from the top surface of the bottom clamp bar.

### CROSS-REFERENCE TO RELATED APPLICATION

This application claims the benefit of, and priority to, U.S. Provisional Patent Application Ser. No. 63/594,922, “Sheet Part Forming Components and Methods,” filed Oct. 31, 2023, which is incorporated herein by reference in its entirety.

### TECHNICAL FIELD

This disclosure relates generally to mechanical clamps.

### BACKGROUND

Sheet metal parts are used in a multitude of applications and across many different industries (e.g., in aerospace, automotive, biomedical, and consumer electronics industries). Sheet metal part forming is the manufacturing process through which sheet metal parts are made. However, sheet metal part forming is very tool intensive, which makes it costly and time consuming to fabricate sheet metal parts. A method for sheet metal part forming is stamping. In stamping, a series of female and male dies that are specific to each design and material are fabricated (tooling). A sheet metal part is formed in a press machine by sandwiching sheet metal between the two dies with force. Stamping requires a large investment in dies and is not accommodating to changes in design and material, making the sheet metal forming process expensive and time-consuming.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIG. 1 is a perspective view of a robotic setup for part forming, according to an embodiment.

FIG. 2A is block diagram of a model, according to an embodiment.

FIG. 2B is a block diagram of a part forming process, according to an embodiment.

FIG. 3 is an image from a simulated part forming process, according to an embodiment.

FIG. 4 is a perspective view of a robotic setup with optical trackers, according to an embodiment.

FIG. 5A is a perspective view of a robot arm with a scanner and load sensor, according to an embodiment.

FIG. 5B is an image generated using scanner data, according to an embodiment.

FIG. 6 includes plots of different forming paths to form a cone, according to an embodiment.

FIGS. 7A-7D illustrate a forming process, according to an embodiment.

FIGS. 8A-8B are perspective views of first and second roller tools, according to some embodiments.

FIG. 9 is a perspective view of a frame holding a sheet, according to an embodiment.

FIG. 10A is a perspective view of a robot arm with a stylus performing a forming operation, according to an embodiment.

FIG. 10B is a perspective view of a robot arm with a trimming performing a trimming operation, according to an embodiment.

FIG. 10C is a perspective view of a robot arm with a hemming performing a hemming operation, according to an embodiment.

FIG. 10D is a perspective view of a tool rack holding a plurality of tools, according to an embodiment.

FIG. 11 is a perspective of a third roller tool, according to an embodiment.

FIG. 12 is a perspective of fourth roller tool, according to an embodiment.

FIG. 13 includes images of two different parts made using a same part design and different forming techniques, according to an embodiment.

FIGS. 14A-14B are block diagrams of other models, according to some embodiments.

FIG. 15 is a block diagram illustrating components of an example machine able to read instructions from a machine-readable medium and execute them in a processor, according to an embodiment.

FIG. 16 is a perspective view diagram of a frame configured to hold an object.

FIGS. 17A-17G are diagrams of an example horizontal clamping system that may be installed on a frame in a horizontal orientation, according to an embodiment.

FIGS. 18A-18I are diagrams of an example vertical clamping system that may be installed on a frame in a vertical orientation, according to an embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Described are embodiments of a mechanical clamp or a clamping system. These clamps and clamping systems may be part of a system for robotic sheet forming as described herein.

A first example mechanical clamping system includes: a bottom clamp bar with holes and a top surface configured to interface with an object to be held; top clamp bars adjacent to each other and arranged along a portion of the bottom clamp bar, the top clamp bars having bottom surfaces configured to interface with the object to be held, the top clamp bars coupled with the bottom clamp bar through fastening members passing between respective holes of the top clamp bars and the holes of the bottom clamp bar; and pins coupled to bottom surfaces of the top clamp bars or top surfaces of the bottom clamp bar, the pins forming pivot points for bottom surfaces of the top clamp bars to pivot toward or away from the top surface of the bottom clamp bar.

A second example mechanical clamping system includes: a bottom clamp bar with a top surface configured to interface with an object to be held; a top clamp bar with a bottom surface configured to interface with the object to be held; a fastening member that passes through a first hole in the top clamp bar and a second hole in the bottom clamp bar; a pivoting receiving member coupled to a portion of the fastening member below the top surface of the bottom clamp bar; and a pivoting pin arranged below the top surface of the bottom clamp bar and engaged with a side of the pivoting receiving member to form a pivot point enabling the fastening member to pivot about the pivot point.

### 1. Robotic Sheet Metal Part Forming

Robotic sheet part forming is a sheet metal part forming technique where a sheet is formed into a desired geometry by a series of incremental deformations applied by a robot. For example, the robot is outfitted with a stiff stylus that delivers deformations to the sheet. The robot may change tools to apply different operations (e.g., trimming and hemming) to the metal part. Multiple robots may be used in the process to provide more accurate control of the process.

Increasing the speed and decreasing the cost to manufacture sheet metal parts is desirable for enhancing product development in all stages of design and manufacturing. In light of this, some embodiments relate to an intelligent machine learning-based system that automates object process parameter generation for real-time control of novel robotic forming of sheet metal, plastics, polymers, and composite parts. Relative to conventional techniques, the disclosed (e.g., fast forming) techniques may enable faster prototyping and may enable rapid customization of mass-produced products. Agile production or prototyping in turn enables development of better-quality products and streamlining production. It may also increase industrial competitiveness in both mature and emerging markets by reducing the time and capital used for developing new components. The benefits may extend further for “lightweighting” strategies employed in various industries (e.g., aerospace and automotive) that want to move towards lighter and higher strength alloys but are slowed down by testing of these alloys. For simplicity, the below descriptions refer to forming parts from sheet metal. However, as indicated above, embodiments described herein may be applicable to forming parts from other materials, such as plastics, polymers, and composites.

Robotic sheet metal part forming overcomes the restrictions of the traditional methods by reducing or removing fabrication of tooling and dies from the production process. Robotic sheet part forming is a sheet metal part forming technique where a sheet is formed into a desired geometry by a series of (e.g. small) incremental deformations applied by a robot. For example, the robot is outfitted with a stiff stylus that delivers deformations to the sheet. Multiple robots may be used in the process to provide more accurate control of the deformations.

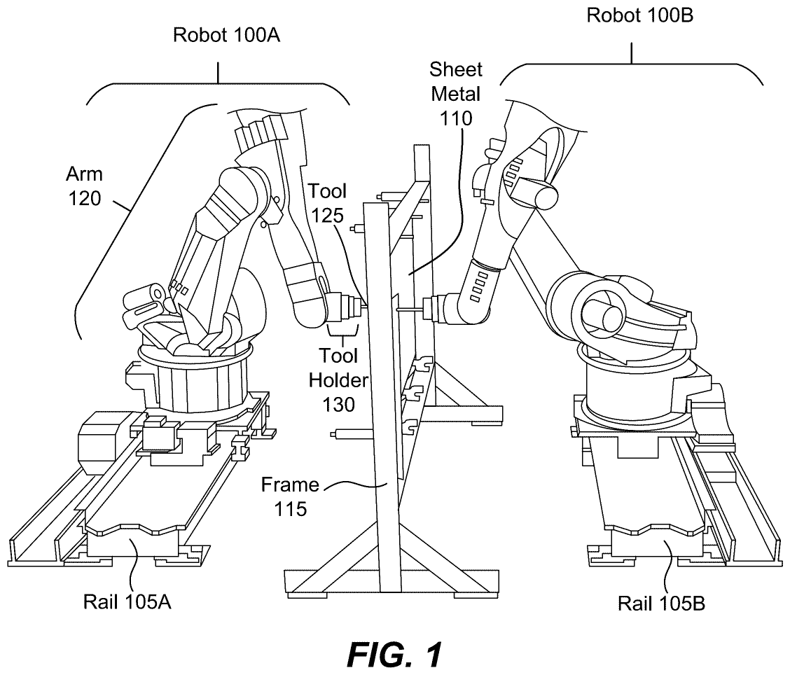

FIG. 1 illustrates an example embodiment of a setup for robotic sheet metal part forming. Two robots 100A and 100B face each other on respective rails 105A and 105B on opposite sides of the sheet metal 110. The sheet metal is supported by a frame 115 (also referred to as a fixture). Specifically, edges of the sheet metal are coupled (e.g., clamped) to the frame to hold the sheet metal in place. The sheet metal is fixed between the two robots to allow easy access from both robots to opposite sides of the sheet. The robots may be high payload industrial robotic arms that can exert forces sufficient to deform the sheet metal (e.g., up to 20,000 N). The amount of force exerted may depend on the material strength and thickness of the sheet. For example, for 2 mm 5xxx aluminum (including aluminum alloys), the peak forces may be 2,000N. In another example, for high strength martensitic steel, the peak forces may be 20,000N. The amount of force may also depend on process parameters. For example, there may be a tradeoff between time duration and force (e.g., a 1 mm stainless steel part takes 4 hours to form with a peak force of 4,000N but it takes 8 hours to form if the peak force is 3,000N). The robots may comprise an articulated 6-axis robotic arm (e.g., arm 120) capable of moving a tool (e.g., tool 125) (also referred to as an end effector) attached to the end of the arm in a three-dimensional space according to 6 degree of freedom motion. The arm may include an actuator system configured to move the robot in space. For example, each segment of the robot arm includes an actuator to move it relative to another arm segment. The end of the robot arm includes a tool holder (e.g., tool holder 130) that enables one or more selectable types of tools to be attached. The tools can include, for example, a hard stylus having ends of varying diameters, shapes, or materials, a roller tool as described below, a spindle tool, a laser tool, a plasma torch, a cutting tool, or a hole making tool. The robots are also slidable along the rails to enable the robots to operate over a wide range of sheet metal sizes and sizes of the part being fabricated. For example, the part can be as small as a few cubic inches or as big as a few cubic feet (in the volume it occupies). The robot's arms may be controlled by a controller (e.g., an external computation system) that takes into account the geometry of the final part and signals from one or more various sensors installed on the robot. The sensors may include, for example, accelerometers, gyroscopes, pressure sensors, or other sensors for detecting motion, position, and interactions of the robot with the sheet metal.

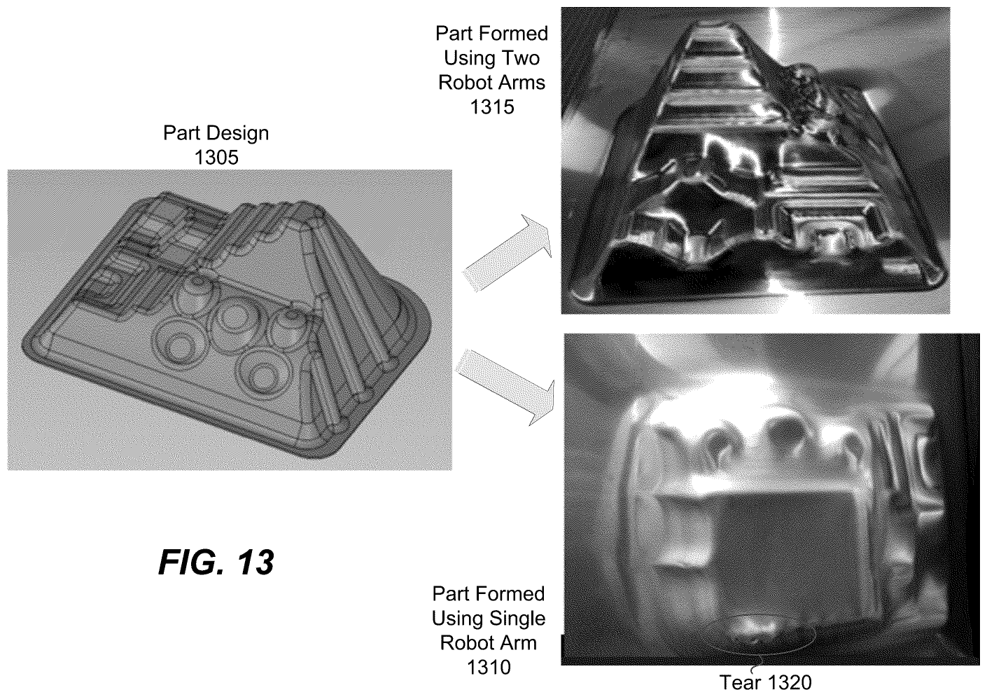

The use of two robots (one on each side of the sheet) may provide several advantages. For example, if only a single robot is used, the sheet may globally deform (instead of locally deform). Thus, using two robots may enable localized deformations. A second robot (also referred to as a support robot) may reduce or prevent tearing of the part by providing supporting pressure on the opposite side of the part. The location of the robots (and their end effectors) with respect to each other may be based on the design of the part and the material and thickness of the sheet. These locations may be determined by a model (described further below). An example of the advantages of two robots is illustrated in FIG. 13. FIG. 13 includes a part design 1305 that illustrates the design of a part to be formed. The images on the right illustrate parts formed based on the design 1305. The bottom right image illustrates a part 1310 formed using only one robot and the top right image illustrates a part 1315 formed using two robots. As illustrated, part 1315 includes more details and more closely resembles the part in 1305. Additionally, the part 1301 includes a tear 1320.

A controller may receive and process sensor data from the sensors to determine the proper parameters (e.g., joint angle values for each joint of the robotic arm) and control the robot arms accordingly. In some embodiments, the robots are controlled to pinch or otherwise apply pressure to the sheet metal with a hard implement (e.g., a stylus) or other tool to form the sheet of metal in accordance with a program applied by the controller to result in a desired geometry. For example, the program controls the robot arms to move in a particular sequence and apply the tool to the sheet metal according to particular programmed parameters at each step (e.g., time step) of the sequence to achieve a programmed geometry. The program (via the robotic arms) may cause the different applied tools to bend, pinch, cut, heat, seam, or otherwise form the metal in accordance with the program.

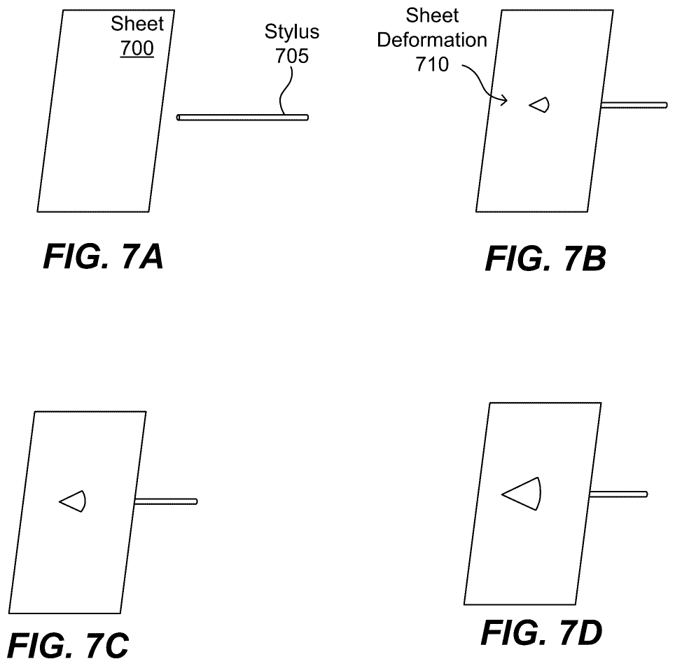

An example part forming process is illustrated in FIGS. 7A-7D. The FIGS. include a sheet 700 and a stylus 705 (e.g., coupled to a robot arm). In FIG. 7B the stylus is applied to the sheet. The result is a deformation 710. FIGS. 7C and 7D illustrate larger deformations that result from the stylus being applied to different locations on the sheet (e.g., in a spiral pattern). To facilitate the deformation into a desired geometry (e.g., a cone), a second tool (e.g., coupled to a second robot arm) may be applied to the opposite surface of the sheet.

### 2. Controller and Model

The controller determines the process parameters to achieve the desired robotic forming operations. Parameters such as the path of the robotic forming tool during the process, its speed, geometry of the forming tool, amount of force, angle and direction of the forming tool, clamping forces of the sheet, etc. may have direct but nonlinear effects on the final geometry. The part forming process may include a set of time steps, where each step describes parameters values for one or more parameters. The part forming process may be iterative. Thus, by executing the system according to the parameter values at each time step, the controller may form the part described in the input design. The parameters values may be determined by the model.

The disclosed robotic system may achieve real-time adaptive control of a part forming process. The method may start with an input design of a part and a (e.g., statistical) model that is generated using a training data set. The training data set may include data from simulation data, and physical process characterization data (such as an in-process inspection or post-build inspection from previously formed parts or geometries). An in-process inspection may include inspecting a part during the forming process. For example, a scanning sensor records the shape of the part as it is being formed. In another example, an eddy current sensor detects defects like cracks. In another example, a force sensor measures the forces applied to the part. A post-build inspection is intended to gather information on a fully formed part. A post-build inspection may include similar inspection techniques as an in-process inspection (e.g., inspecting a part using a scanning sensor or eddy current sensor). However, a post-build inspection may include inspection techniques not performed while the part is being formed (e.g., due to practicality). For example, a fully formed part may be inspected using an x-ray machine.

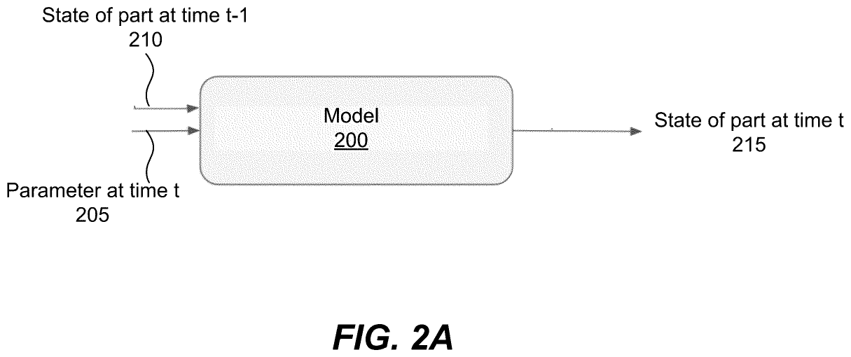

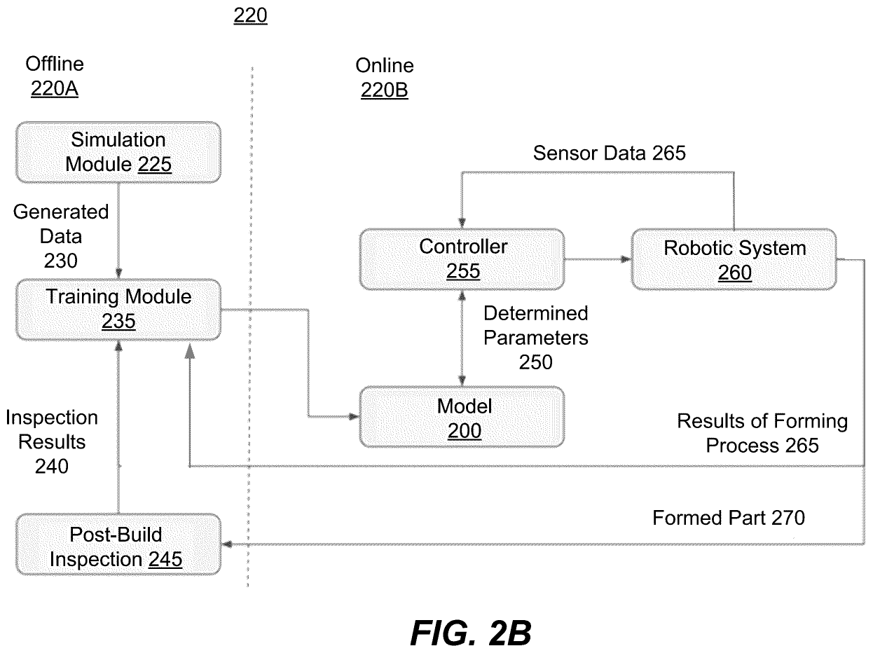

FIG. 2A is a block diagram of an example model 200. As indicated above, the model may be a machine learned statistical model. The model receives one or more parameters 205 to be applied at time step t and the state 210 of the part at time step t-1. The state may refer to the geometry of the part. The model outputs the state 215 of the part at time step t. Thus, for a given state, the model can predict how the part will respond to the application of various parameters. More generally, the model may be used to predict how a material will deform when it goes through a programmed forming process (e.g., over multiple time steps)

A state of the part may be described by a mesh. The mesh may be a graph of coupled nodes, where each node represents a physical point of the part metal. Each node may be described by the following variables: X, Y, Z, F1z, F1x, Fly, F2z, F2x, F2y, thickness, dx, dy, and dz. X, Y, and Z represent the location of the node in space. Thickness indicates the sheet thickness at that node. Each node may be coupled to neighboring nodes (e.g., three neighbors). These coupled nodes represent the part in cartesian space. F1z, F1x, and Fly represent the force that one of the robots (e.g., robot 1) is applying at that node, and F2z, F2x, F2y represent the force another robot (e.g., robot 2) is applying at that node. dx, dy, and dz represent the size of movements capable at a node if the robots pull back from the part at this time (e.g., they capture the elastic strain of the material).

The model can be used to determine the process parameters (e.g., in real time or offline). This method automates the generation of parameters for the robotic forming process (further described in the next paragraph). Due to the optimization process, the generated parameters may not be conceivable by engineers.

After the model is determined (e.g., by a training process), optimization techniques may be used to determine parameters to apply at each (e.g., time) step of the part forming process to create the intended part geometry. For example, for a given time step, the model is applied to various input parameter values according to an optimization technique to determine which parameter values will result in a desired geometry (or a geometry close to the desired geometry). Multiple optimization techniques may be used. Example optimization techniques include gradient descent, Adam optimization, and Bayesian optimization. An optimization technique may be chosen based on the complexity of the desired geometry. The optimization may be done both in the long and short horizons (e.g., time scales). The long horizon optimization may be done offline (before the part forming process begins) to determine steps of the process (e.g., step by step instructions for the robot to achieve the desired geometry). For example, a long horizon optimization may determine how to form a material sheet into a fully formed part. In some embodiments, long horizon optimizations determine a set of intermediate geometries that occur during a part forming process (e.g., intermediate geometries between the sheet and the fully formed part (e.g., for each time step or layer)). However, errors or inaccuracies may accrue over time (e.g., for processes with lengthy build times or processes with a large number of time steps). For example, the part may deform differently than the model predicted. To remedy this issue, short horizon optimizations may be performed during the forming process (online) to reduce or correct errors that may accrue. For example, the model is queried by a (e.g., online) controller that can modify (e.g., correct) steps determined during the long horizon optimization based on the current state of the sheet. For example, for a given time step, instead of assuming the part has a geometry predicted by the long horizon optimization, sensor data may be used to determine the actual geometry of the part. The model may then be queried to determine a new set of parameter values for the time step (or modify the long horizon parameters associated with the time step). For example, the model may be queried to determine which parameter values will form the actual geometry into the predicted geometry (or another intermediate geometry from the long horizon optimization).

While long horizon optimizations may be used to determine an entire part forming process or significant portions of the process, determinations made by short horizon optimizations may be limited to small portions of the part forming process. For example, a short horizon optimization determines a number of interactions (e.g., less than ten) between the end effector and the part. In another example, a short horizon optimization determines interactions between the end effector and the part that will occur during a time window (e.g., less than ten seconds). In another example, a short horizon optimization determines parameter values for a set of time steps (e.g., less than ten time steps). In another example, a short horizon optimization determines how to form a part in a first geometry into a second geometry, where the first and second geometries are intermediate geometries determined by a long horizon optimization. In another example, a short horizon optimization is used to determine how to form a part so that it is a threshold percent closer to a final geometry (e.g., less than ten percent).

In some embodiments, a long horizon optimization is used without short horizon optimizations (e.g., the model has a threshold accuracy or the part forming process has a short build time or a small number of time steps). In some embodiments, short horizon optimizations are used without a long horizon optimization.

Referring back to the model 200, the model may be trained using the data from a simulation module. Additionally, or alternatively, the model 200 may be trained using data (e.g., sensor data) from a physical process that forms a part.

In some embodiments, multiple models are trained. For example, models may be trained using different machine learning techniques. Additionally, or alternatively, models may be trained for specific materials (e.g., steel vs. aluminum), geometries (simple vs. complex), or sheet thickness (e.g., 1 mm vs. 2 mm). Among other advantages, models trained for specific specifications may be more accurate than a general model.

FIG. 2B is a block diagram illustrating an example of the process 220. The process includes an offline learning process 220A and online process 220B. In this context, “online” refers to a time period when a part forming process is occurring (e.g., a robot is deforming a metal sheet to form a part), and “offline” refers to a time before or after a part forming process. The offline process uses simulation data 230, data 265 generated by an in-process inspection, and data 240 generated by a post-build inspection (of the formed part 270) to train model 200. Example data from an in-process inspection is metrology data. Example data post-build inspections includes geometry scans or X-rays of the finished part. After the model 200 is generated, it may be used to determine a part forming process.

The model 200 may also be applied by the controller 255 of the robotic system 260 in the online process. More specifically, the model 200 may determine predictions about the resulting change in geometry from each parameter change at each point in time in the part forming process. In the online process, the controller uses sensors installed on the robotic forming system to obtain sensor data 265 to determine a current geometry of the part. The current geometry may then be input to the model 200. The model predicts the outcome (e.g., a resulting change in geometry) of changes in those process parameters. By iterating over different possible parameters and their outcome predicted by the model, the controller identifies and chooses the (e.g., best) parameter 250 that produces the most desirable outcome to control the robotic forming system through a forming process that achieves the desired geometry. The controller uses the best parameters and may repeats this optimization cycle (e.g., in every step of the process) to improve the outcome.

In addition to the model 200 described above with respect to FIG. 2A, other models are possible. Two examples are provided below.

### 2.1 Blackbox Model

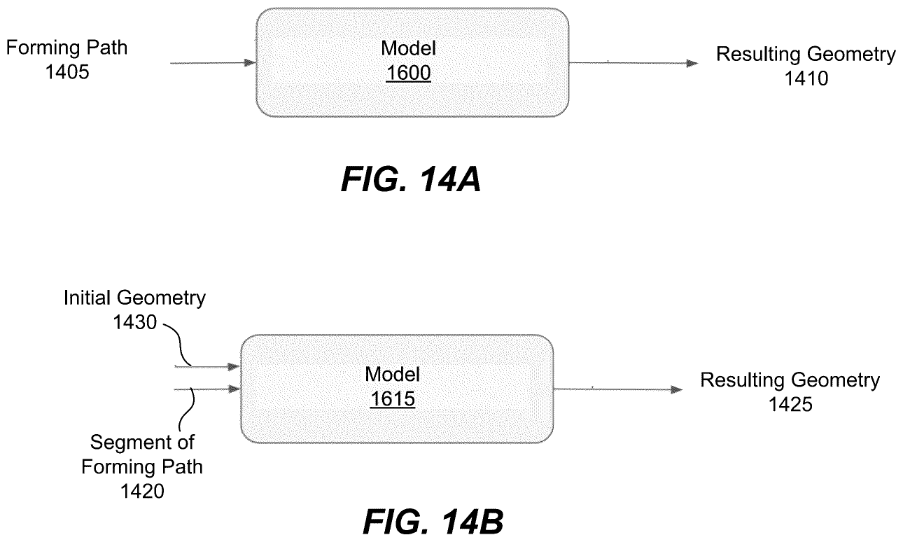

FIG. 14A illustrates an example black box model 1400. The model receives an entire forming path 1405 to be applied to a material sheet and outputs the resulting final geometry 1410 formed by the path. Thus, the model may be trained using data that describes various forming paths and the resulting part geometries. Since the model is not trained to account for physical phenomena (e.g., elastic deformation, global deformation, buckling) the model may be trained using large amounts of training data.

A more complex model is the one that breaks the forming process into layers and tries to predict the effect of various parameter values at each layer. In this context, “layer” refers to a section of a part. For example, a first layer refers to the section that extends one inch away from the original sheet and a second layer refers to the section that extends from the first inch to the second inch. An example of a layer based model is further described below.

### 2.2 Layer Based Model

FIG. 14B illustrates an example layer based model 1415. For input, the model receives a segment of a forming path 1420 and the initial geometry 1430 of a metal part (e.g., a sheet or other geometry). The segment of the forming path 1420 may include enough forming path to form a new layer of the part. The model outputs a resulting geometry 1425 (e.g., the geometry of the part with a new layer). Training data for this model may be generated by determining a forming path (e.g., set of parameter values) that formed a new layer of a part (e.g., scan every layer or every few layers).

Model 1415 may be developed as a sequence model which means it may be any of the sequence architectures (e.g., RNN, LSTM, Transformers). This model has more advantages than model 1400 since it is agnostic to general changes to the policy for forming robots. For example, model 1415 may be used to model inset adding or doing ADSIF or grouped DSIF. That being said, in some embodiments, model 1415 does not capture physical phenomena that may occur during each layer or group of layers.

### 3. Simulation

Referring back to FIG. 2B, the simulation module 225 simulates interaction of a robot-controlled tool, such as a stylus, with a sheet metal or other material. In one example, the simulation may be done using a finite element method. The simulation may be performed to generate simulation data indicating various input parameter values and resulting part geometries. The simulation may be replicated (e.g., in computer data centers) to generate large amounts of simulation data 230. The simulation speed and rate of data generation can be significantly enhanced using GPUs. The large amounts of data may be beneficial for training the model (e.g., instead of only relying on data generated from using a robot arm to physically deform a sheet).

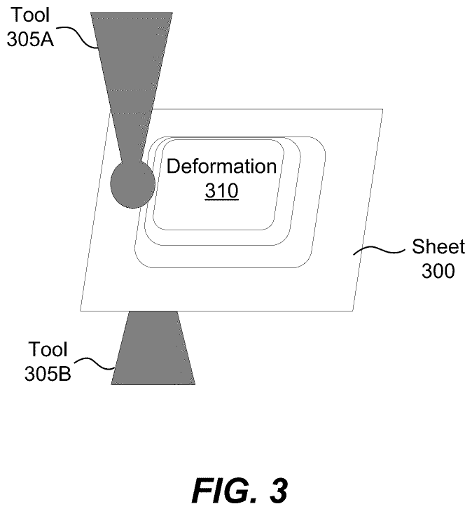

FIG. 3 illustrates an example image from a simulation. The image includes a three-dimensional simulation of a sheet 300 and two tools 305A and 305B interacting with the sheet. The tools may be coupled to robot arms. Tool 305A is interacting with the top surface of the sheet, and tool 305B (partially blocked by the sheet) is interacting with the bottom surface of the sheet. The tools are pressing into the sheet to form a deformation 310. In the example of FIG. 3, the deformation is a rectangular hill protruding upward.

Referring back to FIG. 2B, input for the simulation module 225 may be a specification for a sheet, such as its material properties (e.g., the stress-strain curve) and failure criteria (e.g., mechanical failure of the sheet). Failure criteria may be one or more rules that specify when a part has torn or cracked. The criteria may be based on thickness of the sheet, the material properties, and the amount strain put into the sheet. The simulation module may also receive a specification for one or more programmed forming paths (e.g., determined heuristically) and the type and size of the end effector (e.g., stylus). The simulation module outputs, for a sequence of time steps of the programmed control process, the resulting formed geometry.

By varying different input process parameters such as the forming path, its speed, and the geometry being formed, the simulation module 225 can generate a (e.g., large) data set indicating how a specific metal is deformed with this process (e.g., how metal deforms in response to certain input parameters). The simulation data is used to train a model (e.g., by a training module). The model may be trained using one or more different machine learning techniques and constructs, such as Neural Networks, Random Forests, Decision trees, or regressions. in some embodiments, the training techniques are supervised learning techniques.

In some embodiments, the simulation data is used to train an initial model. The initial model may then be refined or retrained using data from physical part forming processes to increase the accuracy of the model.

In the examples described above, the model is generally described in the context of forming operations. However, the model (or another model) may be trained to predict other part operations, such as trimming or hemming.

### 4. Instrumentation of Robotic Part Forming

The model created using simulation data may be further trained from data derived from an actual physical process that uses a robot arm and an actual sheet. The physical system is equipped with one or more different types of sensors. Example sensors include: (1) encoders in the robot joints that provide positional information as determined by the position of the joints, (2) optical trackers (e.g., a camera) that track the location of robot in (e.g., 3D) space, (3) surface scanners to generate as-built geometry of the part before, during, and after the forming process (surface scanners may have a point accuracy of 0.5 mm), (4) load sensors that determine the force the forming end effectors apply on the sheet, (5) ultrasonic sensors (e.g., electromagnetic acoustic transducer or EMAT) for real-time monitoring of material thickness, and (6) eddy current sensors (e.g., pulsed eddy current) for real-time monitoring of the metallurgical state of metallic sheet. In some embodiments, if the surface scanner is attached to the robot arm, surface scanner data may be stitched together based on the encoder data to determine the geometry of a part (the location of the scanner depends on the position of the arm).

The encoders may be attached to each joint on the robot to track its actual movement, the optical trackers may be mounted around the manufacturing cell. This allows the optical trackers to capture images that include tracking targets installed on the robotic arms and the frame holding the sheet in place. The load sensor and scanner may be attached to the end-of-arm tooling to track forming forces and deformation of the sheet during the process.

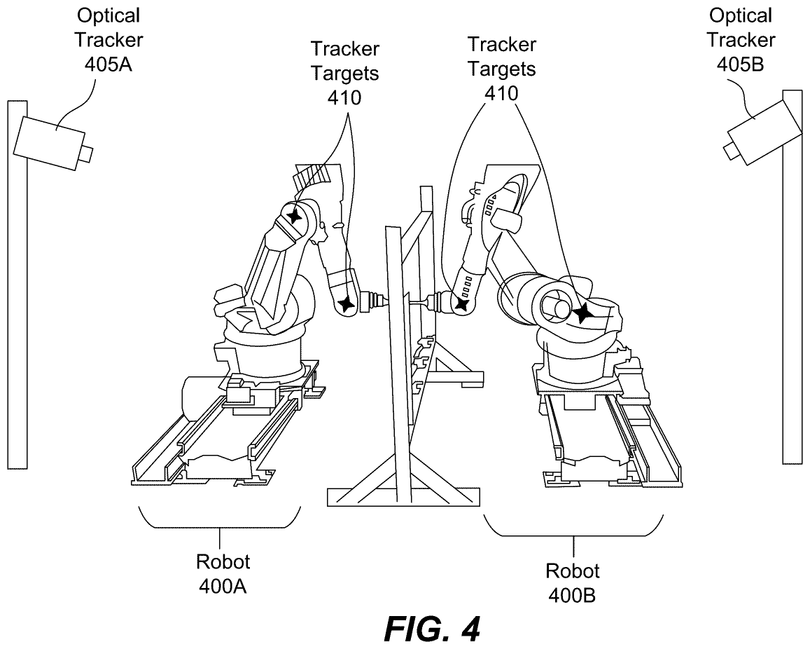

Example optical trackers are illustrated in FIG. 4. FIG. 4 includes two robots 400A and 400B in a manufacturing cell. FIG. 4 also includes two optical trackers 405A and 405B. The robots include tracker targets 410 located at various points on the robots. The optical trackers capture images of the robots and identify the locations of the tracker targets in the images. Thus, the locations of the robots in space can be determined. Although not illustrated, the sheet metal or frame may also include tracking targets to track locations of the robots relative to the metal sheet or frame.

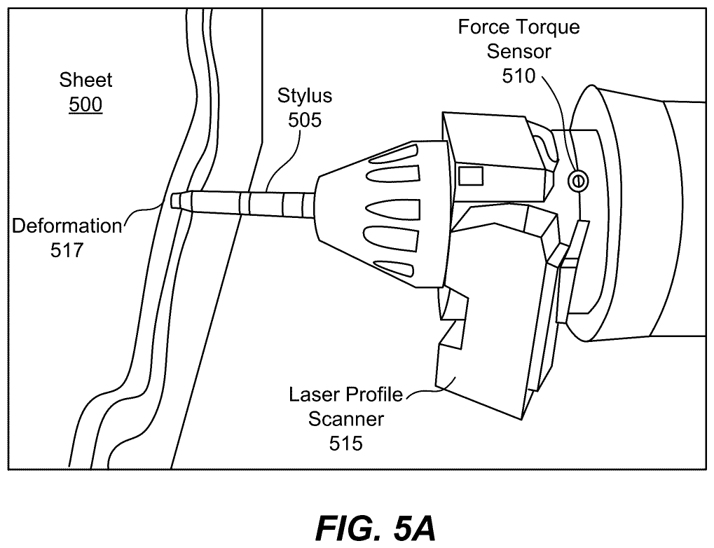

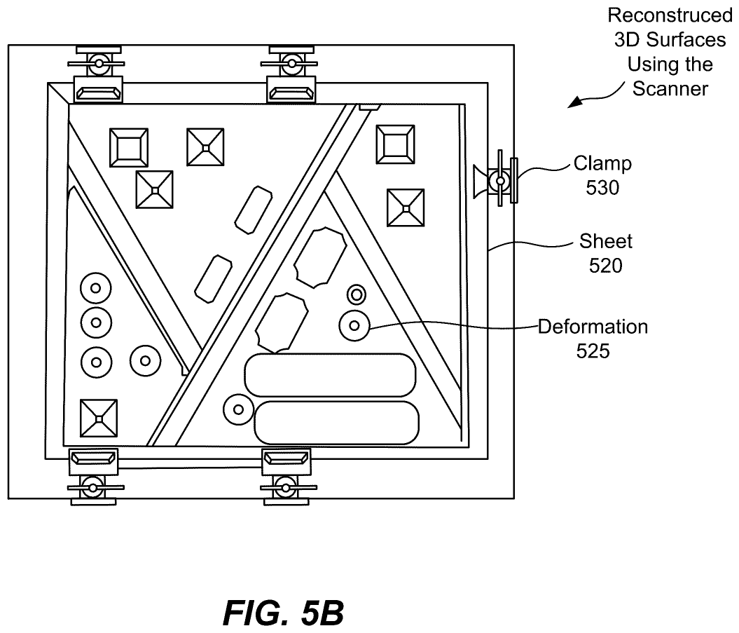

In some embodiments, the robot arm is outfitted with a scanner and a load sensor (e.g., force/torque sensor) as illustrated in FIG. 5A. FIG. 5A illustrates a zoomed in view of an end of a robot arm. The robot arm interacts with a metal sheet 500 via a stylus 505 to create a deformation 517. The arm also includes a force torque sensor 510 and a laser profile scanner 515. FIG. 5B is an example image generated using data from the laser profile scanner 515. FIG. 5B illustrates a reconstructed three-dimensional surface of the metal sheet. The image includes clamps 530, a sheet 520, and deformations 525 in the sheet.

With the sensors described above, accurate data can be captured to characterize steps of a part forming process.

Referring back to FIG. 2B, the training module 235 obtains data 230 generated by the simulation module 225 (e.g., parameters and estimated final geometry of a part for a given forming process), sensor data 265 generated during a part forming process, and data 240 generated during a post-build inspection 245 (e.g., actual final geometry of the part). The training module 235 trains a machine-learned model 200 that maps input parameters to a resulting geometry.

### 5. Using the Model in Control Loop

Once a process model 200 is generated using the above-described training process, the model may be applied in the control process of the robotic forming in two ways. The model may as an input takes a specification for a sheet, such as its material properties (e.g., stress-strain curve) and failure criteria. It may also receive a specification for forming paths (which may initially be determined offline) and the type and size of the tool. The model can be either queried online for optimized process parameters for each time step of the process in real-time, or it can be used in the design of experiments offline to determine optimal policy for forming the part. The policy here refers to general pathing strategies in forming a part.

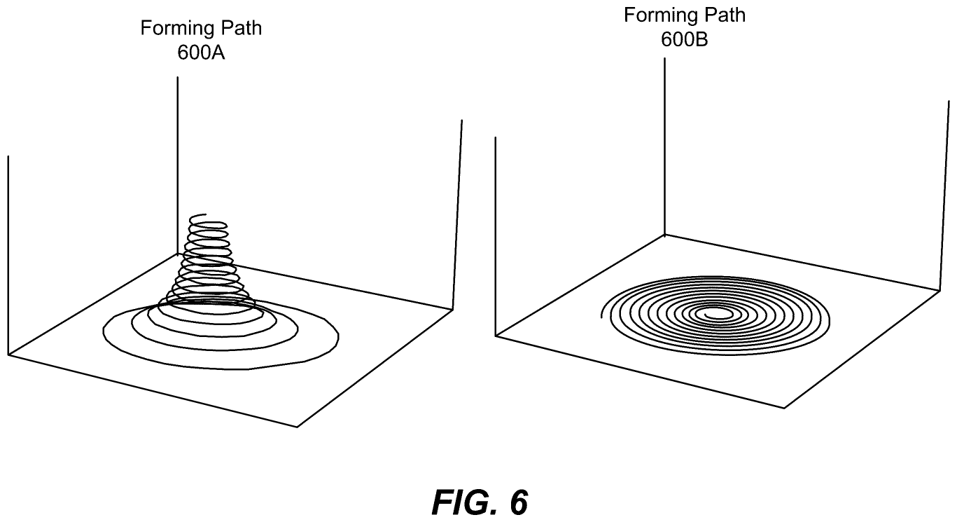

FIG. 6 illustrates two different strategies for forming a cone in an example forming process. Both can be evaluated (e.g., by the controller 255) using the machine-learned model 200 to determine a preferred path. The model can also be used (e.g., by the controller 255) to determine a combination of strategies for different locations in the part that might yield the best outcome. On the left side of FIG. 6 is a depiction of a forming path 600A that starts the forming from outside and moves in a circular pattern toward the inside of a cone (first forming the largest radius and then moving toward forming a smaller radii). On the right side of FIG. 6 is depiction of a forming path 600B that starts forming from inside and moves in a circular pattern toward the outside of a cone (first forming the tip of the cone with the smallest radius and then progressively forming larger and larger radii). The model can be used predict the outcome of both strategies to determine the best strategy or their combination for different parts.

Two categories of systems discussed below may increase the speed of sheet metal part fabrication using robots. The first system and design (“Forming With Rollers”) increases the speed of the forming process itself, while the second (“Integration of Downstream Processes”) addresses downstream processes from part forming to decrease total fabrication time.

6. Forming with Rollers

To increase the speed of the part forming process, an end-effector tool may be configured to interact with the sheet metal with reduced (e.g., low) friction forces. Reducing friction allows for reduction in vibrations in the sheet and hence allows increased speed of forming without negative impact on the geometrical accuracy of the formed part. It may also result in better surface quality (e.g., reduced tearing and galling) compared to tools not configured to reduce friction (e.g., static forming tools).

An example tool configured to reduce friction is a stylus made of a material (or coated with a material) configured to reduce friction. Thus, if the stylus is dragged across the surface of a part, the reduced friction may reduce or eliminate surface degradations and increase the path speed.

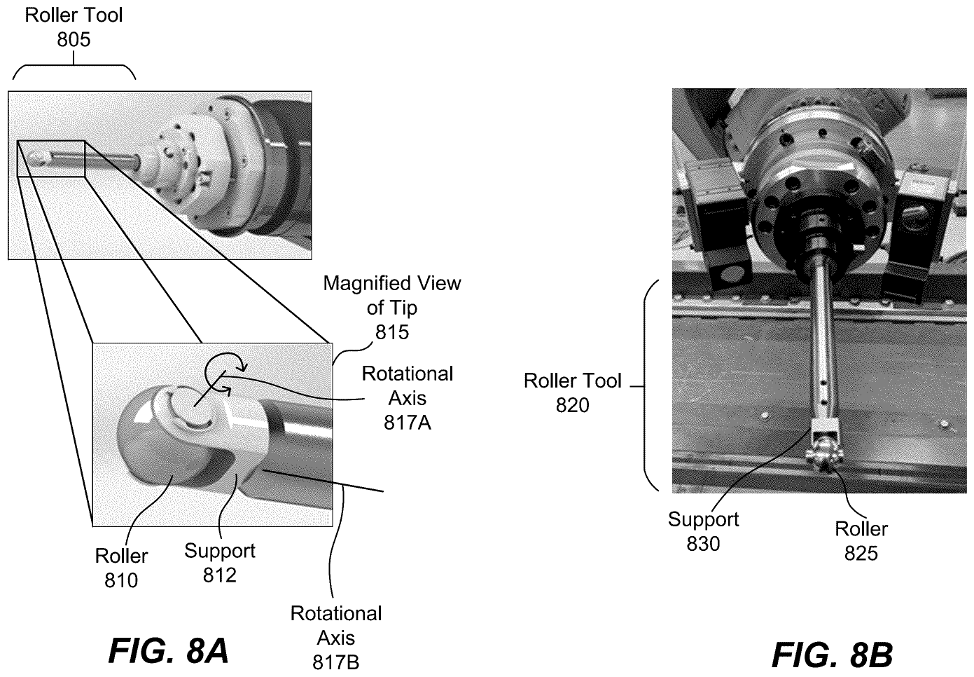

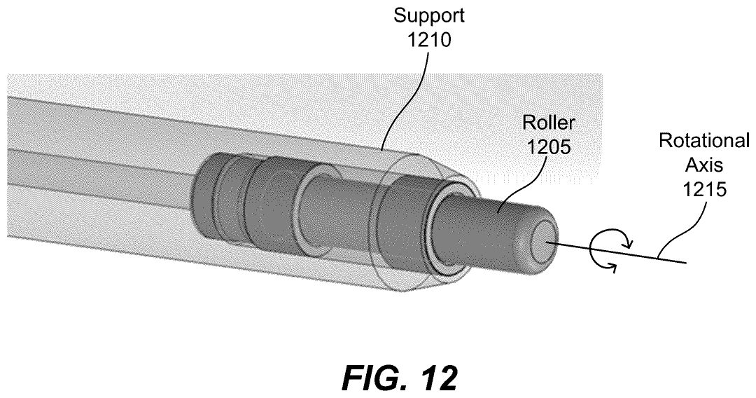

Other tools configured to reduce friction may include roller tools. Roller tools may result in lower friction forces than a stylus. Different rollers with different radii and shape can be used to accommodate for different features in the part design. FIGS. 8A-8B illustrate example embodiments of roller tools. FIG. 8A includes an image of a roller tool 805 coupled to a robot arm and a magnified view of the tip of the roller tool 815. The tip of the roller tool includes a roller 810 held in place by a support 812. The support allows the roller to rotate about an axis 817. FIG. 8B is an image of a larger roller tool 820. Similar to FIG. 8A, tool 820 has a roller 825 and a support 830. Another example of a single axis roller is illustrated in FIG. 12. The tool includes a roller 1205 with a support 1210. The roller can rotate about axis 1215, which is parallel to a long axis of the support.

In some embodiments, the roller can only roller about a single rotational axis (e.g., as in FIGS. 8A and 8B). However, the robotic system is controlled, via the controller, to orient the roller tool so that the roller rolls along the desired direction of movement (the desired direction of movement may be set by the program). Said differently, the roller tool may be oriented so that the rotational axis of the roller is perpendicular to the direction of movement of the roller tool. The illustrated rollers are specifically suitable for part forming with articulated 6-axis robots, since the robots can take advantage of the 6 degrees of freedom to align a roller in the direction of the movement during part forming. The roller may be held with the same mechanism as the stylus or other tools using a tool holder that is mounted at the end of the robotic arm.

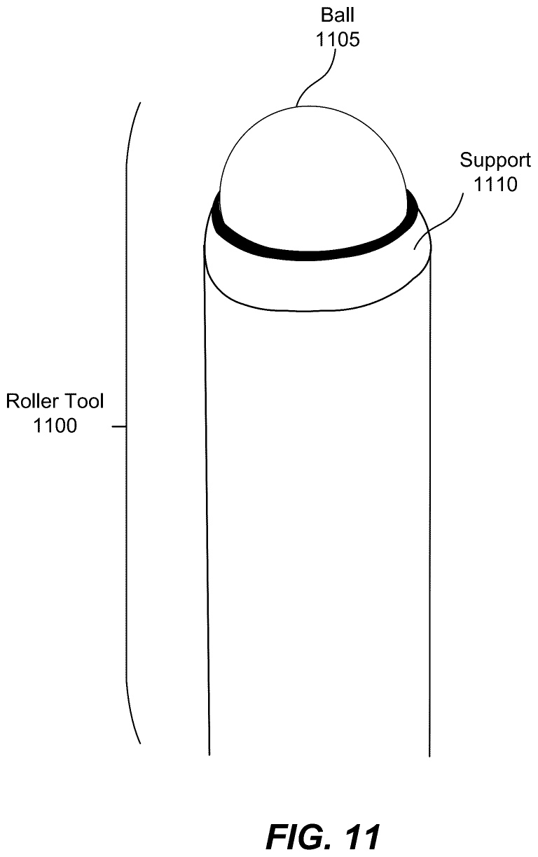

In some embodiments, a roller tool includes a roller that can rotate about multiple rotational axes. An example, of this is illustrated in FIG. 11. FIG. 11 includes a roller tool 1100. The tool 1100 includes a ball 1105 in a socket that may be part of a support 1110 for the ball. The ball can rotate in the socket. Thus, the tool can move in different directions along a part surface without the robot rotating the support along the long axis. Due to the socket configuration, the roller tool 1100 have less friction than a stylus but more friction than a single axis roller (e.g., as illustrated in FIGS. 8A and 8B).

The disclosed roller design installed on a robotic setup allows for robotic part forming with reduceds friction, hence reduced forces which then allows for better surface quality of the formed part and increased speed of the forming process.

### 7. Integration of Downstream Processes in the Forming Setup

Sheet metal part forming may be one of many manufacturing steps performed to produce a final sheet metal part. For example, a sheet metal part also goes through trimming, hole making, hemming, or other processing steps after the part forming process. Traditional methods involve transferring a sheet metal part from one specialized manufacturing station to another, performing each manufacturing step in each corresponding station to produce the delivering the final part. This results in increased manufacturing time due to the time for physically moving the part from one station to another.

Each of the downstream processes generally has its own specific tooling. For example, for trimming a part, it is desirable to use a geometry specific frame that can hold the geometry of the part while a trimming operation is performed.

In some embodiments, the robotic system allows for performing two or more (e.g., all) downstream manufacturing steps in the same station using the same robotic setup, thus avoiding moving of the part and decreasing the total fabrication time. Each downstream process may use a different tool. For example, when performing trimming (e.g., hole making), the robot arm may attach different tools such as a spindle, laser, or a plasma torch. The robotic arm can be controlled to automatically change the tool through software instructions of the program executed by the controller (e.g., controller 255). For example, the controller can control the robot arm at varying times throughout the process to perform a programmed operation on the sheet metal with a particular tool, to control an actuator to release a tool from the tool holder (e.g., into a tool rack), and to cause the robot arm to attach a new tool from the tool holder (e.g., from the tool rack) for performing a subsequent operation.

In some embodiments, the steps that enable automatic integration of downstream processes in the same station may include the following. (1) the robot goes to a tool rack and picks up a forming tool (e.g., a stylus) using predefined software instructions sent to the robot. (2) the robot forms a part from a flat sheet of metal through software defined path and parameters. (3) After the part is formed, the robot moves back to the tool rack, disengages (e.g., drops) the forming tool, and picks up a trimming tool. This step may also be automated with software instructions. (4) The robot performs a trimming operation on the part with the trimming tool. If further downstream processes, such as hemming (e.g., bending), are used to finish the part, the system may continue from step 3 until no more processes are left to perform. If a station includes multiple robots, the robots may work in conjunction using the same or different tools to achieve a desired process (e.g., a forming or trimming process).

If a manufacturing area includes multiple cells (e.g., each including two robot arms), instead of each cell changing tools to perform different operations, each cell may be assigned to a specific operation. In these embodiments, a part may be moved from one cell to another after each operation on the part is complete.

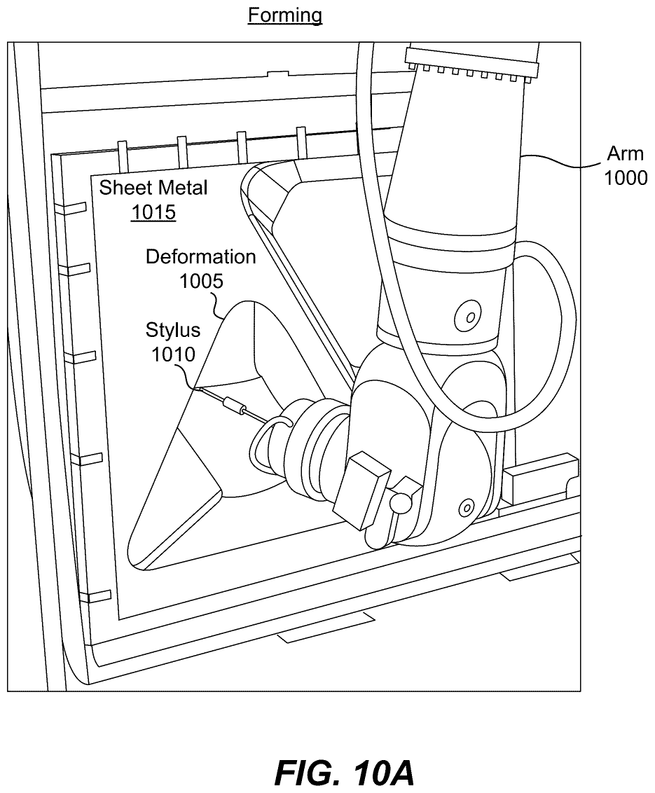

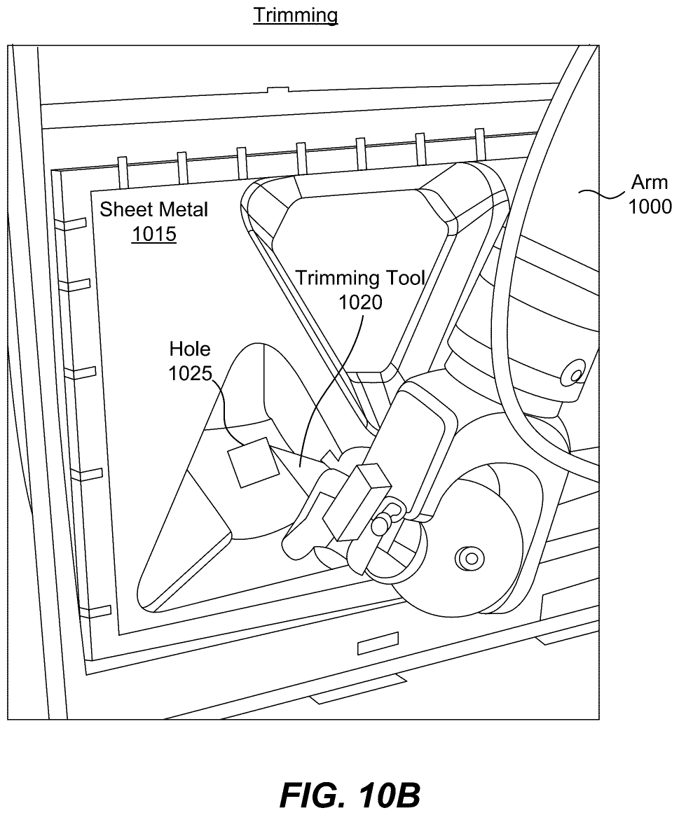

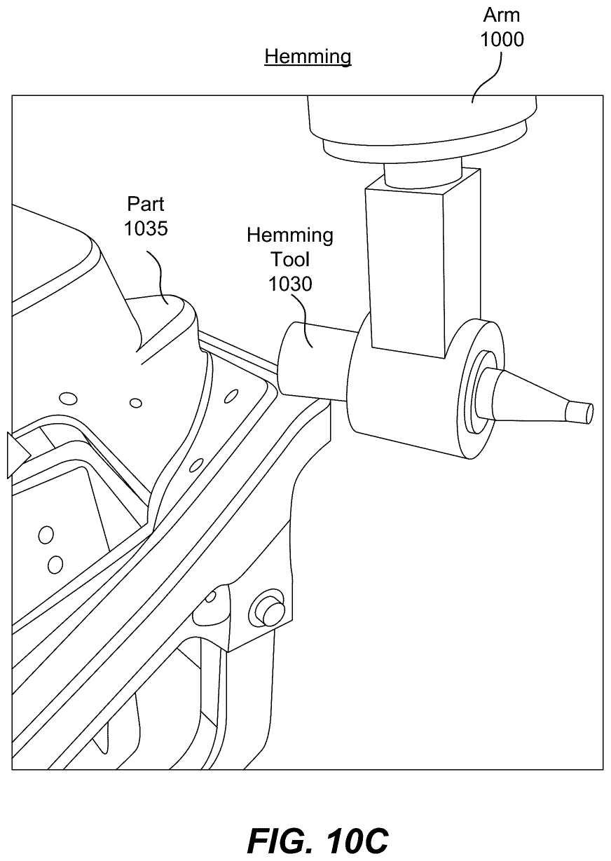

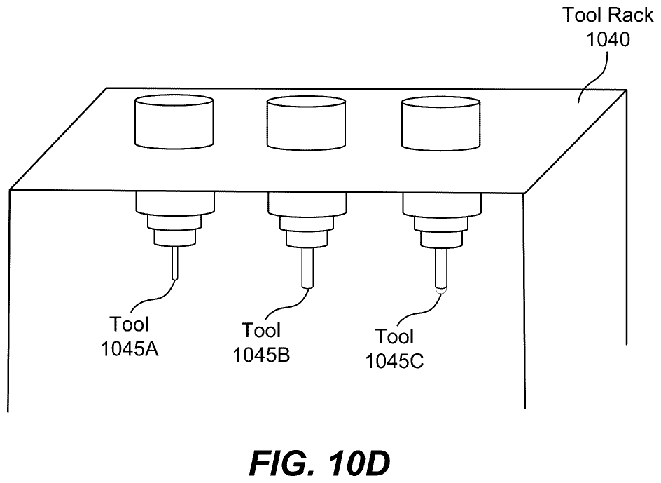

FIG. 10 includes images of various manufacturing processes described above. FIG. 10A illustrates a robot arm 1000 forming a deformation 1005 by pressing a stylus 1010 against a piece of sheet metal 1015. FIG. 10B illustrates the robot arm 1000 with a trimming tool 1020. The trimming tool is used to cut a hole 1025 in a portion of the deformation. To determine the location of the hole, a controller of the arm (e.g., controller 255) may compare a design of the deformation (e.g., in a computer-aided design file) with the current geometry of the deformation (the current geometry may be determined from sensor data). For example, after the deformation is formed, the robot picks up a scanner sensor, scans the deformation and, based on a design of the deformation, determines the path to trim the deformation. After that, the robot may pick up a trimming tool. FIG. 10C illustrates the robot arm 1000 with a hemming tool 1030. The hemming tool is used to bend a corner of a part 1035. FIG. 10D is a perspective view of a tool rack 1040 holding a plurality of tools 1045. The rack may be placed near a robot arm (e.g., arm 1000) so that the arm can exchange tools. In the example of FIG. 10D, tools 1045A and 1045B are styli and tool 1045C is a roller tool.

### 8. Frame

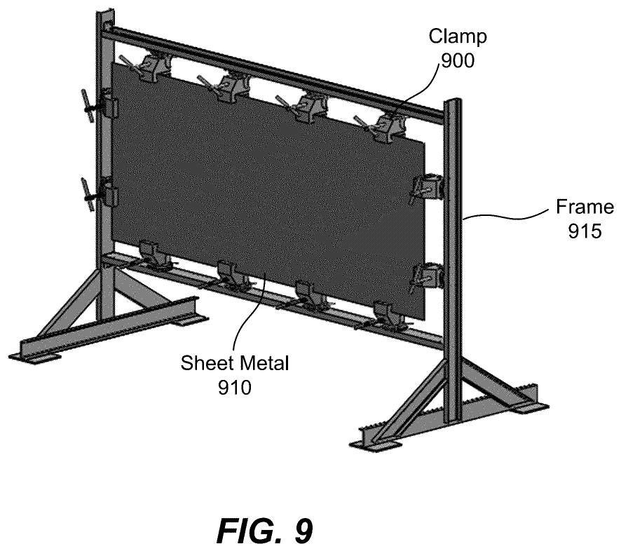

FIG. 9 is a perspective view of a frame 915 (also referred to as a fixture), according to an embodiment. In the example of FIG. 9, the frame 915 includes a series of clamps 900 that hold the sheet metal 910 in place. Specifically, the frame surrounds the edges of the sheet metal and the clamps are clamped to edge portions of the sheet metal 910. The clamps may be hydraulic or electric (e.g., servo). The clamps may be electronically operated. The frame and clamps may be sturdy enough to hold the sheet metal in place as the robot arms apply different processes (e.g., deformation forces) to the sheet. The frame enables access to large sections of the sheet metal 910 with robotic arms. Thus, it may eliminate the need for any method-specific modification in the fixture that is traditionally required with downstream operation from sheet forming.

Thus, the stand design and software-controlled tool changer for controlling the robotic arms allows for automated downstream operations from forming of the sheet metal parts such as trimming, bending, and hemming without removing the part from the fixture and requiring geometry specific fixture.

### 9. Mechanical Clamping Systems

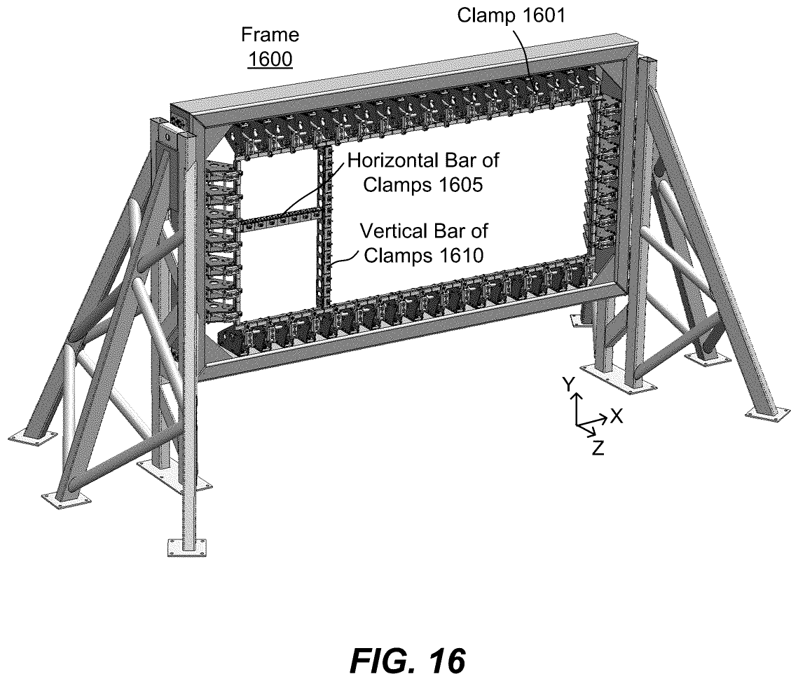

FIG. 16 is a diagram of a frame 1600 with clamps (e.g., 1601) configured to hold an object (e.g., a sheet of metal). Frame 1600 is rectangular in shape and includes clamps (e.g., 1601) integrated along edges of the frame 1600 to hold sides of an object (e.g., a metal sheet). Frame 1600 additionally includes a vertical bar of clamps 1610 and a horizontal bar of clamps 1605. These bars are detachable and reconfigurable to enable frame 1600 to hold different sized objects and/or to hold multiple objects at once. More specifically, the bars can be positioned at different locations in the frame and can couple to different positions of each other. For example, these bars enable frame 1600 to hold an object that isn't large enough to reach the clamps integrated along the edges of frame 1600.

Furthermore, additional, or fewer horizontal or vertical bars can be attached to frame 1600. Furthermore, the vertical and/or horizontal bars may be manufactured in a variety of sizes (e.g., lengths) to accommodate different sized objects. In some embodiments, clamps integrated along edges of frame 1600 (e.g., 1601) are the same clamps as those of the horizontal bar of clamps 1605 and/or the vertical bar of clamps 1610.

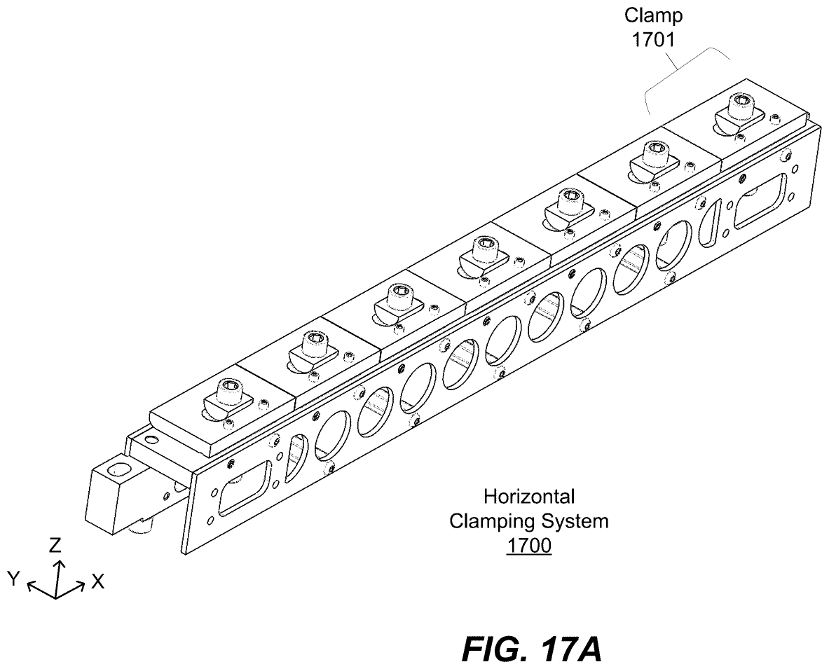

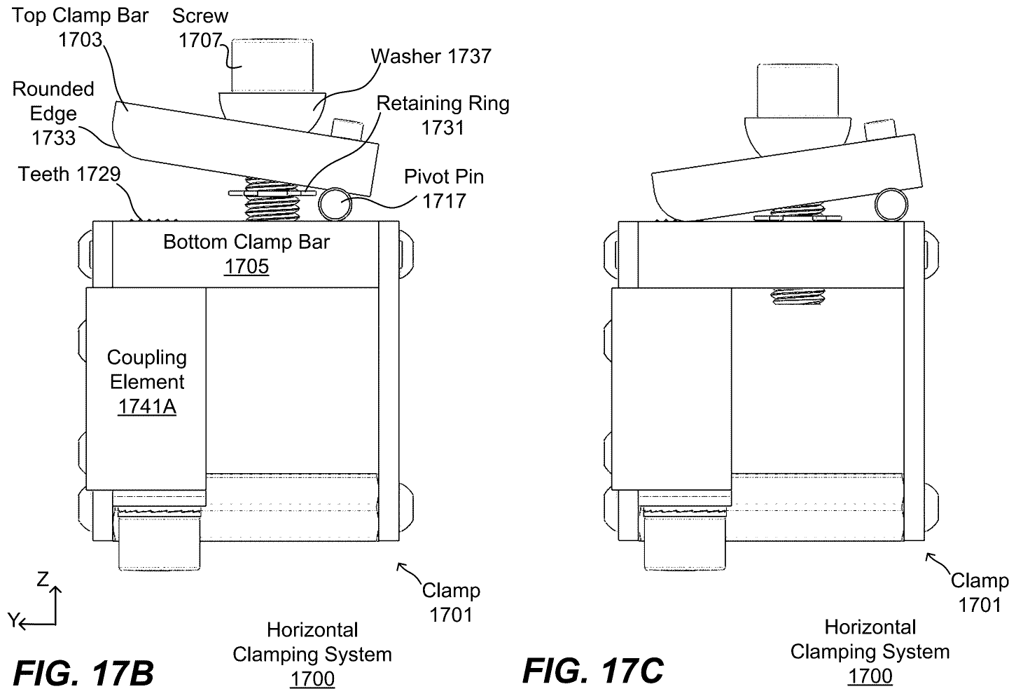

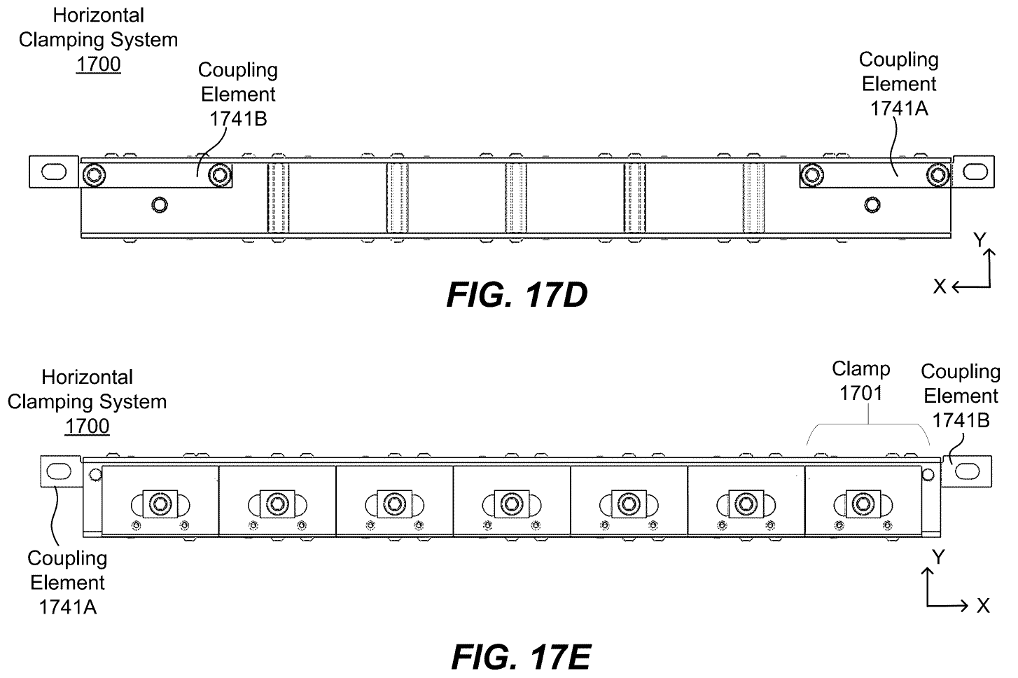

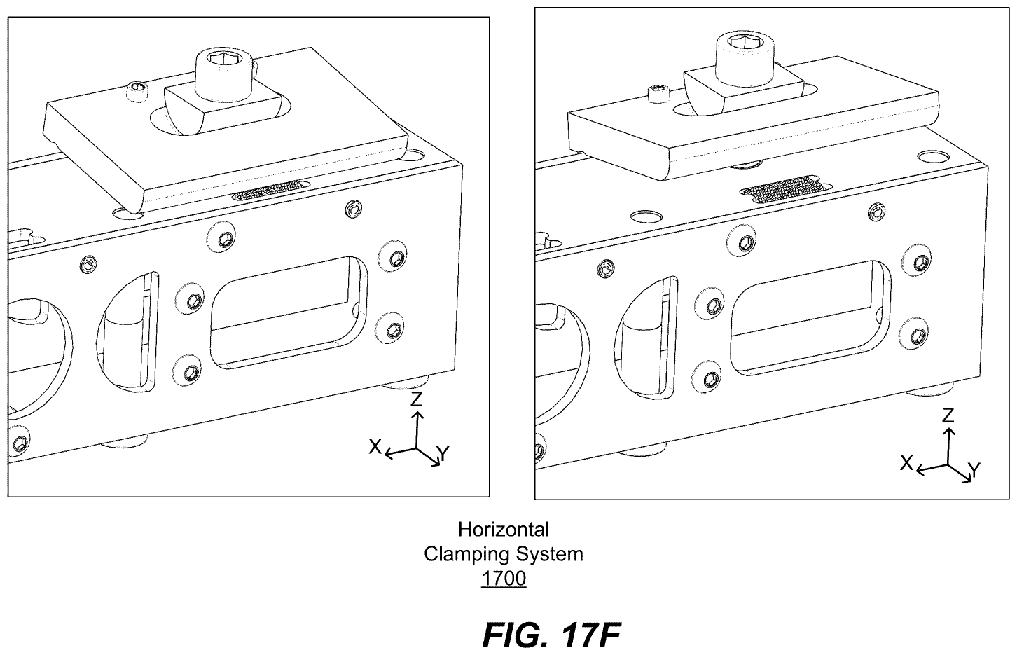

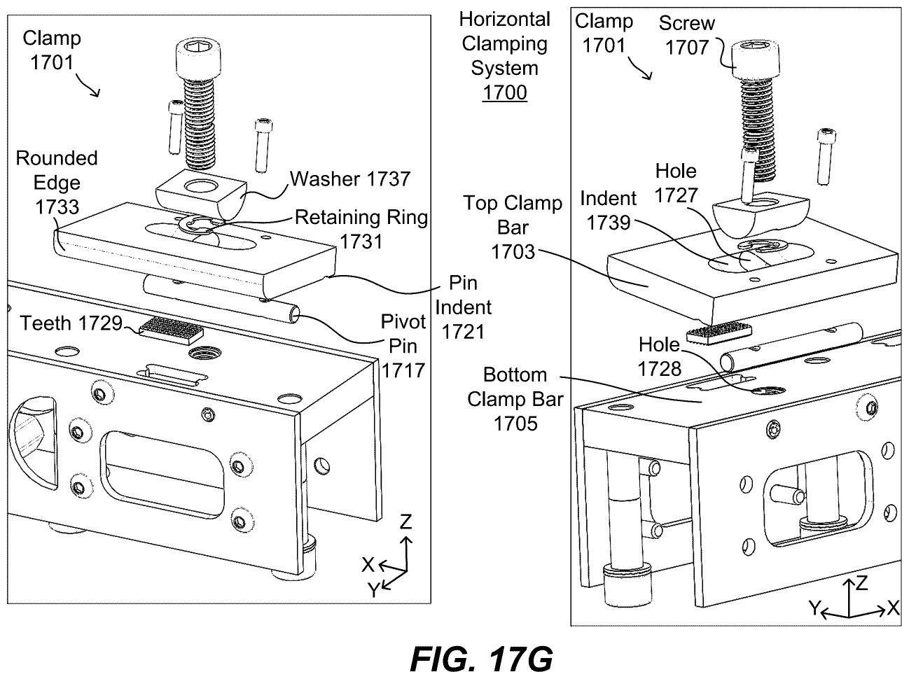

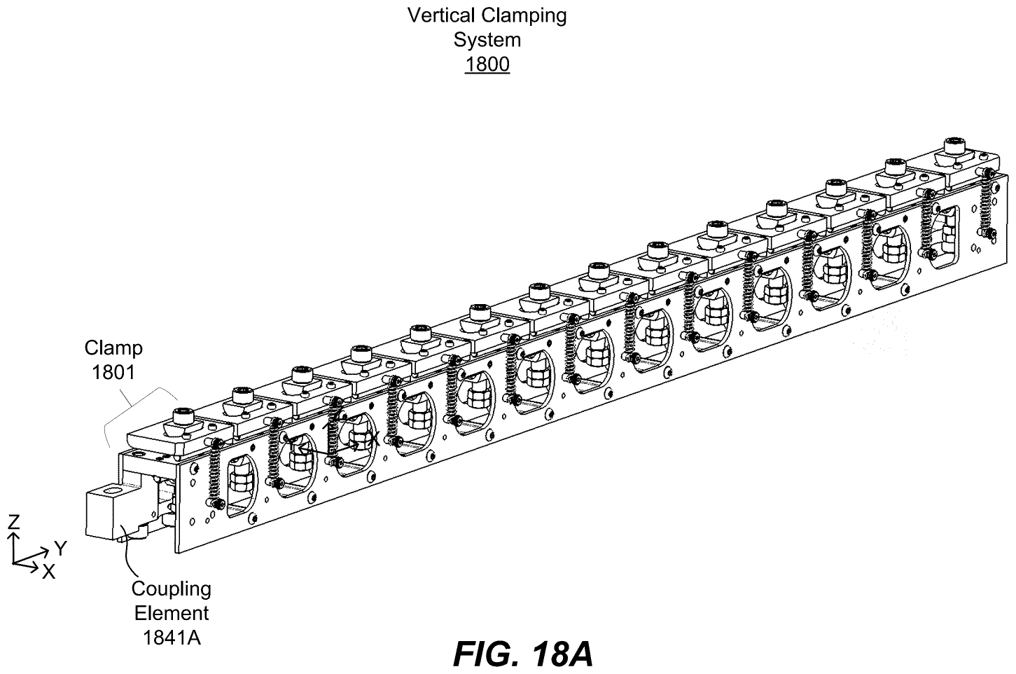

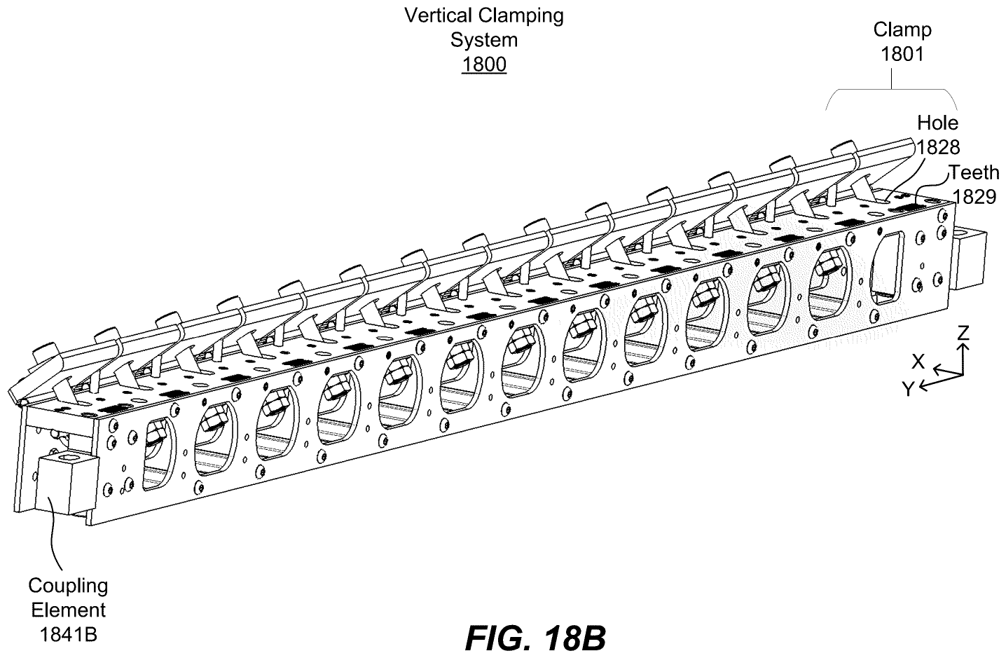

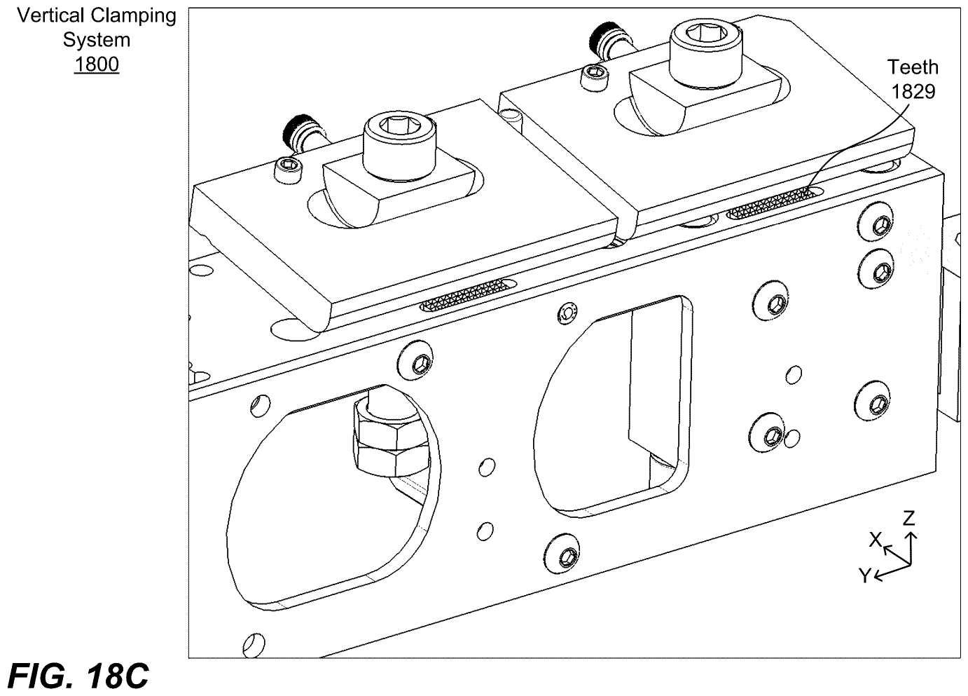

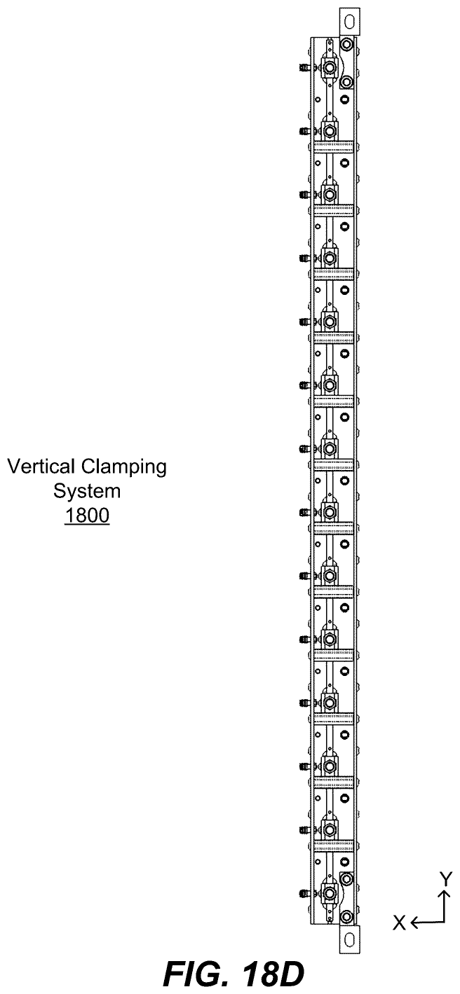

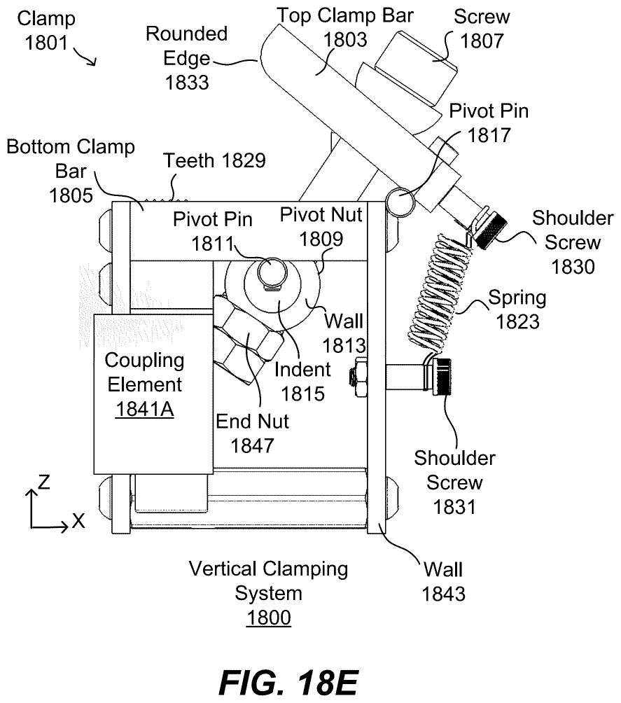

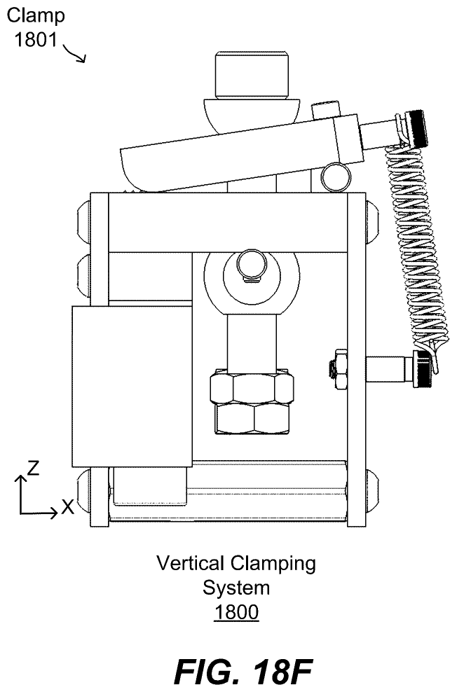

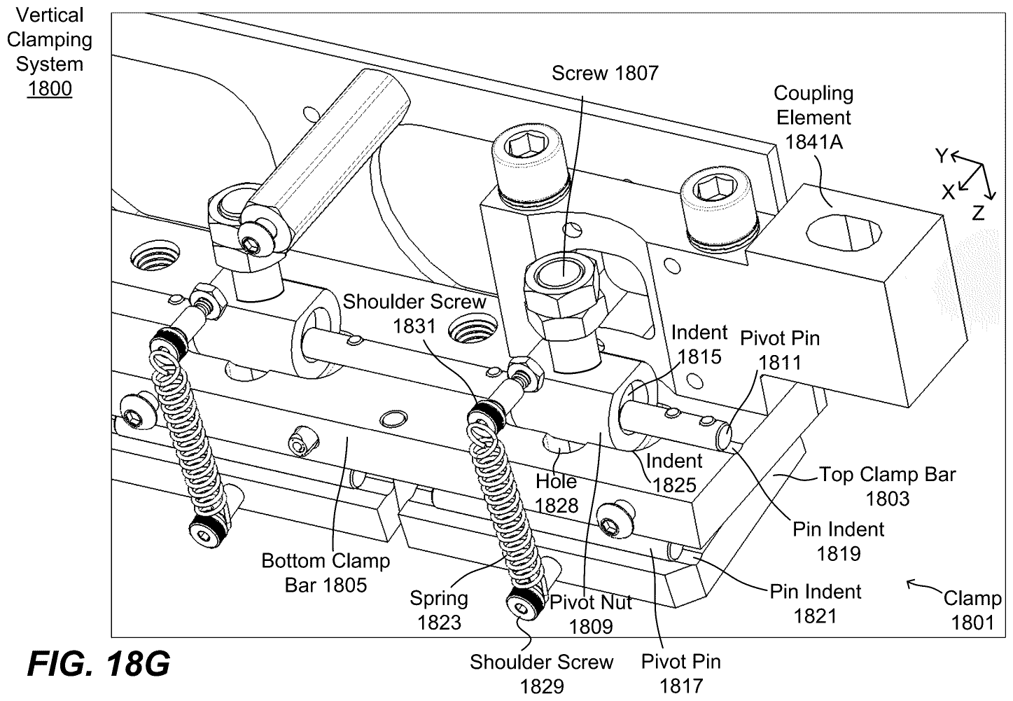

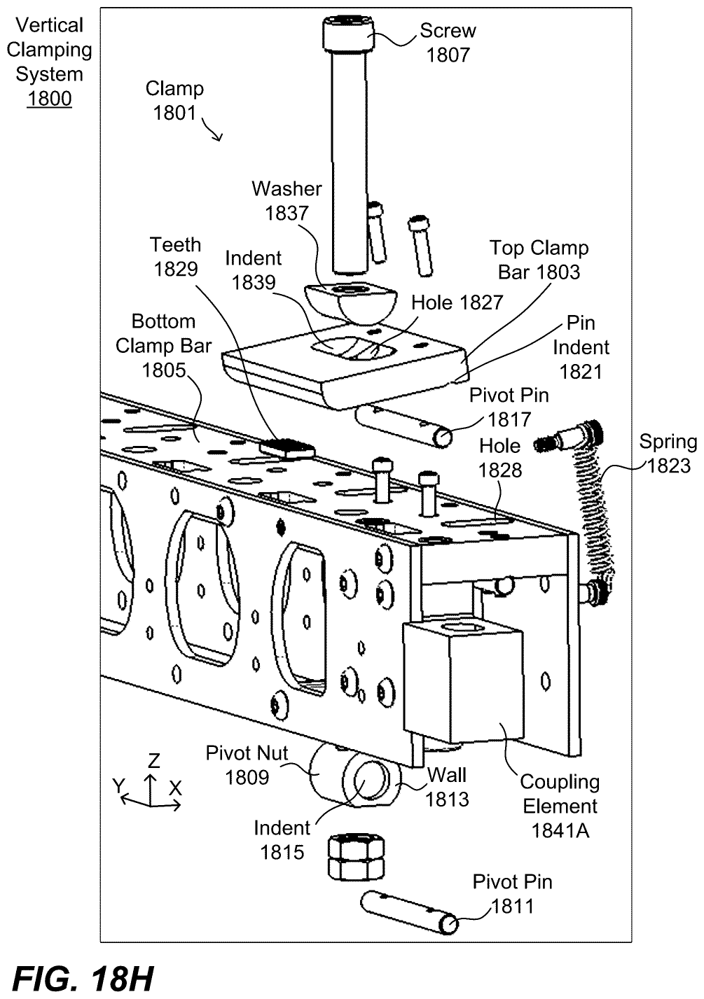

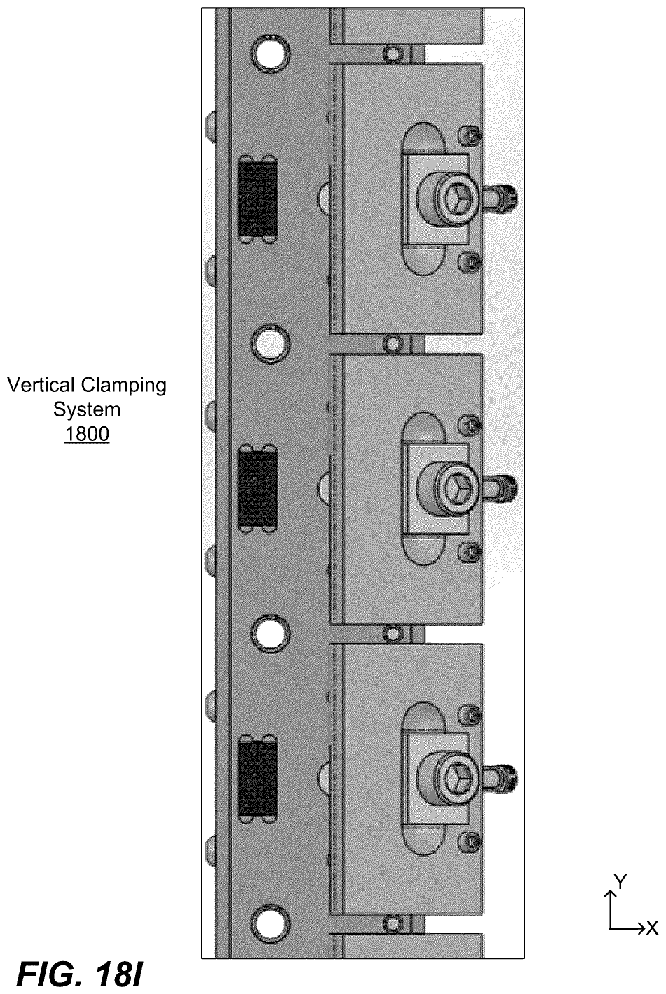

A horizontal bar of clamps (e.g., 1605) may be referred to as a horizontal clamping system. A vertical bar of clamps (e.g., 1610) may be referred to as a vertical clamping system. Horizontal clamping systems and vertical clamping systems are further described below. The terms “horizontal” and “vertical” are relative terms used for convenience. For example, a horizontal clamping is not required to be arranged horizontally. Similarly, a vertical clamping system is not require to be arranged vertically. Furthermore, although horizontal and vertical clamping systems are described below as having different components and features, a horizontal clamping system may have components and/or features described with respect to the vertical clamping features and vice versa. For example, the clamp described with respect to FIG. 17 may include shoulder screws and a spring as described with respect to FIG. 18.

Furthermore, components of clamping systems are described below using relative terms such as “top,” “bottom,” “side,” “below,” and “above.” These terms and similar terms are used for convenience to describe the position of one component relative to another component. These terms and similar terms do not describe a required orientation. For example, depending on the orientation of a clamping system, a “top clamp bar” may be below or next to a “bottom clamp bar.” In another example, depending on the orientation of a clamping system, a “top surface” of a component may face downward or in a lateral direction relative to the ground.

### 9.1 Horizontal Clamping Systems

FIGS. 17A-17G (“FIG. 17” collectively) are diagrams of an example horizontal clamping system 1700 that may be installed on a frame in a horizontal orientation. FIG. 17A is a perspective view of the horizontal clamping system 1700, where the clamps are in a closed position. FIG. 17B is a side view of the horizontal clamping system 1700, where the clamps are in an open position. FIG. 17C is a side view of the horizontal clamping system 1700, where the clamps are in a closed position. FIG. 17D is a rear view of the horizontal clamping system 1700. FIG. 17E is a front view of the horizontal clamping system 1700. FIG. 17F includes two perspective view diagrams of an end of the horizontal clamping system 1700. In the left diagram, the end clamp is in a closed position, and in the right diagram, the end clamp is in an open position. FIG. 17G includes to two exploded view diagrams of an end of the horizontal clamping system 1700.

Horizontal clamping system 1700 includes a set of seven clamps adjacent to each other (other embodiments may include additional or fewer clamps), and each of the seven clamps include the same parts (other embodiments may include clamps with different parts). Each of the seven clamps may open or close about by rotating about the same axis, which is parallel to the x-axis (e.g., each of the clamps rotate about pivot points that are aligned with each other). However, for convenience, FIG. 17 only includes labels for components of clamp 1701. Any descriptions of clamp 1701 or components of clamp 1701 may be applicable to the other claims of horizontal clamping system 1700.

Clamp 1701 includes top clamp bar 1703, bottom clamp bar 1705, and screw 1707. Screw 1707 is a structure passes through hole 1727 in top clamp bar 1703 and hole 1728 in bottom clamp bar 1705. Note that a clamp (e.g., 1701) is not limited to use of a screw (e.g., 1707). More generally, a clamp may include a fastening member, such as a threaded fastening member (example threaded fastening members include a screw, a threaded rod, and a bolt). Clamp 1701 can be closed by screwing screw 1707 into hole 1728 (which results in top clamp bar 1703 moving closer to bottom clamp bar 1705) and opened by unscrewing screw 1707 from hole 1728 (which results in top clamp bar 1703 moving farther from bottom clamp bar 1705). More specifically, as clamp 1701 is closed, top clamp bar 1703 tilts forward toward bottom clamp bar 1705 as the top portion of screw 1707 translates toward bottom clamp bar 1705 (an example closed clamp position is illustrated in FIG. 17C). Similarly, as clamp 1701 is opened, top clamp bar 1703 tilts backward away from bottom clamp bar 1705 as the top portion of screw 1707 translates away from bottom clamp bar 1705 (an example open clamp position is illustrated in FIG. 17B). The titling (also referred to as rotation) of top clamp bar 1703 in clamp 1701 may be due to multiple a pivot point formed by pivot pin 1717, which is further described below.

In the perspective of FIGS. 17B-17C, top clamp bar 1703 is a block of material with a bottom surface configured to interface with an object to be held by clamp 1701. Similarly, bottom clamp bar 1705 is a block of material with a top surface configured to interface with an object to be held by clamp 1701. In the example of FIG. 17, bottom clamp bar 1705 is a single bar shared by all seven clamps, however this isn't required.

In the example of FIG. 17, top clamp bar 1703 includes a rounded edge 1733. Since top clamp bar 1703 pivots toward bottom clamp bar 1705 when clamp 1701 is being closed (counter clockwise in the perspective of FIGS. 17B-17C), rounded edge 1733 helps enable clamp 1701 to hold objects of varying thicknesses (along the z-direction).

As previously described, screw 1707 passes through hole 1727 in top clamp bar 1703 and hole 1728 in bottom clamp bar 1705. Hole 1727 may be larger than the diameter of screw 1707 enough to allow top clamp bar 1703 to pivot (e.g., by zero to five, ten, fifteen, or twenty degrees) relative to screw 1707 (and bottom clamp bar 1705), which increases the clearance for loading and unloading an object in the clamp. For example, hole 1727 has an oblong shape (e.g., hole 1727 is a slot) with the long axis being in the rotation direction of top clamp bar 1703 about the pivot point as further described below (said differently, the long axis is perpendicular to the rotational axis).

Pivot pin 1717 is a cylindrical pin (however other pin shapes are possible). In the perspective of FIGS. 17B and 17C, pivot pin 1717 is coupled to the bottom surface of top clamp bar 1703 (e.g., via screws). However, in some embodiments, pivot pin 1717 is coupled to another component, such as the top surface of bottom clamp bar 1705. Pivot pin 1717 may form a pivot point that (e.g., in conjunction with hole 1727 being larger than the diameter of screw 1707 as previously described) allows top clamp bar 1703 to rotate relative to screw 1707 (and bottom clamp bar 1705). More specifically, due to the position of pivot pin 1717 relative to bottom clamp bar 1705 and top clamp bar 1703, top clamp bar 1703 may pivot toward or away from the top surface of bottom clamp bar 1705 about an axis parallel to the x-axis. More specifically, pivot pin 1717 is positioned at rear portions of the interface surfaces of top clamp bar 1703 and bottom clamp bar 1705, which enables the front portions to pivot toward or away from each other as screw 1707 translates.

Top clamp bar 1703 (or bottom clamp bar 1705) may include a pin indent 1721 (also referred to as a recess) configured to receive at least a portion of pivot pin 1711, which may help installation of pivot pin 1711 and may help hold pivot pin 1711 in place during operation (e.g., in addition to any other fastening mechanisms, such as screws).

During opening or closing of clamp 1701, the top of screw 1707 can translate relative to bottom clamp bar 1705 (by being screwed or unscrewed). Clamp 1701 may include retaining ring 1731 coupled to a portion of screw 1707 between the interface surfaces of top clamp bar 1703 and bottom clamp bar 1705. Retaining ring 1731 may remain coupled to the same portion of screw 1707, even when screw 1707 translates. Thus, in the perspective of FIGS. 17B-17C, retaining ring 1731 can push against the bottom surface of top clamp bar 1703 to push top clamp bar 1703 upward when screw 1707 is translated upward, resulting in clamp 1701 opening (more specifically, resulting in a front portion of top clamp bar 1703 pivoting away from a front portion of bottom clamp bar 1705).

In the perspective of FIGS. 17B-17C and 17G, clamp 1701 includes washer 1737 on a portion of screw 1707 above top clamp bar 1703 (e.g., above the surface configured to interface with an object). Washer 1737 includes a rounded surface (e.g., a cylindrical surface or a barrel-shaped surface) that faces the top surface of top clamp bar 1703. Top clamp bar 1703 includes a rounded indent 1739 configured to receive at least part of washer 1737, which may facilitate movement (e.g., rotation) of top clamp bar 1703 relative to screw 1707.

Among other advantages, clamp 1701 enables top clamp bar 1703 and screw 1707 (as well as washer 1737, retaining ring 1731, and pivot pin 1717) to be removed from clamp 1701 by unscrewing screw 1707 past a threshold (e.g., unscrewing screw 1707 out of bottom clamp bar 1705). For example, removal of these components may make installation of horizontal clamping system 1700 on a frame easier and lighter. Furthermore, removal of these components may make it easier to place an object to be held on bottom clamp bar 1705 (and the components may be added back afterwards). Furthermore, if these components are removed (e.g., for all clamps on horizontal clamping system 1700), horizontal clamping system 1700 to be used as a support beam. For example, horizontal clamping system 1700 can be placed behind an object held in a frame (held by other clamps) to support the object and/or reduce or eliminate bending or flexing of the object (e.g., during part forming operations).

In some embodiments, a clamp (e.g., 1701) includes teeth to increase the hold of the object. For example, clamp 1701 includes serrated teeth 1729. Teeth 1729 may be a ˜1 millimeter insert and may be installed in a recess in bottom clamp bar 1705 (recess is not labeled in FIG. 17). The material, shape, and structure of serrated teeth 1729 may depend on the types of objects to be held. For example, serrated teeth 1729 is configured to hold an edge of sheet metal and is made of tungsten carbide.

Vertical clamping system 1700 includes coupling elements 1741A and 1741B on sides of bottom clamp bar 1705. Coupling elements 1741A, 1741B enable horizontal clamping system 1700 to be coupled to (e.g., mounted to) a frame or another horizontal or vertical clamping system (e.g., via bolts or screws).

### 9.2 Additional Example Horizontal Clamping Systems

Additional example embodiments of clamping systems are described below. Although references are made to vertical clamping system 1700 in the below descriptions, the example embodiments described below are not required to include the components or features previously described with respect to vertical clamping system 1700.

Some aspects relate to a mechanical clamping system (e.g., horizontal clamping system 1700) configured to hold a side of a sheet of material (e.g., 110, 520, 700, 910, 1015) in a frame (e.g., 115, 915, 1600), the mechanical clamping system including: a bottom clamp bar (e.g., bottom clamp bar 1705) with a top surface configured to interface with the sheet to be held; top clamp bars (e.g., including top clamp bar 1703) adjacent to each other and arranged along a portion of the bottom clamp bar, the top clamp bars having bottom surfaces configured to interface with the sheet to be held; screws (e.g., including screw 1707) that pass through holes in the top clamp bars (e.g., including hole 1735) and holes in the bottom clamp bar (e.g., including hole 1727) (a screw may have a long dimension that is parallel to the z-axis as illustrated in FIG. 17); and pins (e.g., including pivot pin 1717) coupled to bottom surfaces of the top clamp bars or top surfaces of the bottom clamp bar, the pins forming pivot points for bottom surfaces of the top clamp bars (e.g., about an axis parallel to the x-axis illustrated in FIG. 17) toward or away from the top surface of the bottom clamp bar.

In some aspects, the mechanical clamping system further includes retaining rings (e.g., including retaining ring 1731) coupled to portions of the screws between the top surface of the bottom clamp bar and the bottom surfaces of the top clamp bars.

In some aspects, the retaining rings are positioned on the screws to push the bottom surfaces of the top clamp bars to pivot away from the top surface of the bottom clamp bar responsive to the screws being moved upward (e.g., unscrewed for example from the bottom clamp bar and/or moved along the +z-axis as indicated in FIG. 17).

In some aspects, the top clamp bars include rounded edges (e.g., including rounded edge 1733) configured to interface with sheets that have a range of thicknesses.

In some aspects, pivot axes of the pivot points are parallel to each other (e.g., see FIG. 17 where the top clamp bars are arranged open or close about the same pivot point).

In some aspects, the techniques described herein relate to a mechanical clamping system, wherein pivot axes of the pivot points are aligned with each other (e.g., see FIG. 17 where the top clamp bars are arranged open or close about the same pivot point).

In some aspects, the holes in the top clamp bars are oblong in directions perpendicular to pivot axes of the pivot points (e.g., see FIG. 17G, where hole 1735 is oblong in along the y-axis). Among other advantages, an oblong hole causes a top clamp bar to pivot (about an axis parallel the x-axis in FIG. 17) when the screw is moved upward (e.g., along the +z-axis) without the screw pivoting (e.g., outside of a threshold tolerance (e.g., due to spacing between threads)).

In some aspects, the mechanical clamping system further includes: washers (e.g., including washer 1737) on portions of the screws above the bottom surfaces of the top clamp bars, the washers including rounded surfaces facing the top clamp bars (e.g., see FIGS. 17B-C and 17G).

In some aspects, top surfaces of the top clamp bars include indentations (e.g., including indent 1739) shaped to receive (e.g., to match) the rounded surfaces of the washers (e.g., see FIG. 17G).

In some aspects, the mechanical clamping system further includes coupling elements (e.g., coupling element 1741A and coupling element 1741B) coupled to opposite ends of the mechanical clamping system (e.g., the bottom clamp bar). The coupling elements are configured to mount the bottom clamp bar to the frame.

Other aspects include components, devices, systems, improvements, methods, processes, applications, computer readable mediums, and other technologies related to any of the above.

### 9.3 Vertical Clamping Systems

FIGS. 18A-18I (“FIG. 18” collectively) are diagrams of an example vertical clamping system 1800 that may be installed on a frame in a vertical orientation. FIG. 18A is a first side perspective view of a vertical clamping system 1800, where the clamps are in a closed position. FIG. 18B is second side perspective view of the vertical clamping system 1800, where the clamps are in an open position. FIG. 18C is a second side perspective view of an end of the vertical clamping system 1800, where the clamps are in a closed position. FIG. 18D is a rear view of the vertical clamping system 1800. FIG. 18E is a top view of the vertical clamping system 1800, where the clamps are in an open position. FIG. 18F is a top view of the vertical clamping system 1800, where the clamps are in a closed position. FIG. 18G is a rear perspective view of an end of the vertical clamping system 1800. FIG. 18H is an exploded view of an end of the vertical clamping system 1800. FIG. 18I is a front view of a portion of the vertical clamping system 1800.

Vertical clamping system 1800 includes a set of fourteen clamps, and each of the clamps include the same parts (other embodiments can include additional or fewer clamps and different clamps may include different parts). However, for convenience, FIG. 18 only includes labels for components of clamp 1801. Any descriptions of clamp 1801 or components of clamp 1801 may be applicable to the other claims of vertical clamping system 1800.

Clamp 1801 includes top clamp bar 1803, bottom clamp bar 1805, and screw 1807. Screw 1807 is a structure that passes through hole 1827 in top clamp bar 1803 and hole 1828 in bottom clamp bar 1805. Note that a clamp (e.g., 1801) is not limited to use of a screw (e.g., 1807). More generally, a clamp may include a fastening member, such as a threaded fastening member (example threaded fastening members include a screw, a threaded rod, and a bolt). Clamp 1801 can be closed by screwing screw 1807 (which results in top clamp bar 1803 moving closer to bottom clamp bar 1805) and opened by unscrewing screw 1807 (which results in top clamp bar 1803 moving farther from bottom clamp bar 1805). Pivot nut 1809 may include threads that receive threads of screw 1807.

More specifically, as clamp 1801 is closed, top clamp bar 1803 and the top portion of screw 1807 tilt forward toward bottom clamp bar 1805 in addition to top clamp bar 1803 and the top portion of screw 1807 translating toward from bottom clamp bar 1805 (an example closed clamp position is illustrated in FIG. 18F). Similarly, as clamp 1801 is opened, top clamp bar 1803 and the top portion of screw 1807 tilts backward away from bottom clamp bar 1805 in addition to top clamp bar 1803 and the top portion of screw 1807 translating away from bottom clamp bar 1805 (an example open clamp position is illustrated in FIG. 18E). The titling (also referred to as rotation) of top clamp bar 1803 and screw 1807 in clamp 1801 may be due to multiple pivot points which are further described below.

Top clamp bar 1803 (and the top portion of screw 1807) may rotate enough (or sufficiently) for an object to be placed in the clamp by traveling along the clamp direction. For example, in the view of FIG. 18I, an edge of an object can contact bottom clamp bar 1805 by traveling in straight along the −z direction (in other words, straight into the page). Among other advantages, having top clamp bar 1803 (and the top portion of screw 1807) tilted away in the open position enables easier installation of an object (e.g., a piece of sheet metal) in the clamp, especially when the clamp is installed on a frame since the installation direction to mount an object in a frame is similar to the clamping direction. For example, in FIG. 16 an object may be inserted into the clamps on frame 1600 by moving an object along the −z direction, which is also the clamping force direction.

In the perspective of FIGS. 18E-18F, top clamp bar 1803 is a block of material with a bottom surface configured to interface with an object to be held by clamp 1801. Similarly, bottom clamp bar 1805 is a block of material with a top surface configured to interface with an object to be held by clamp 1801. In the example of FIG. 18, bottom clamp bar 1805 is a single bar shared by all fourteen clamps, however this isn't required.

In the example of FIG. 18, top clamp bar 1803 includes a rounded edge 1833. Since top clamp bar 1803 pivots toward bottom clamp bar 1805 when clamp 1801 is being closed (counter clockwise in the perspective of FIG. 18E), rounded edge 1833 helps enable clamp 1801 to hold objects of varying thicknesses (along the z-direction).

Clamp 1801 includes pivot nut 1809, however note that a clamp (e.g., 1801) is not limited to use of a nut (e.g., 1809). More generally, a clamp may include a (e.g., threaded) receiving member for a (e.g., threaded) fastening member (e.g., 1807). Pivot nut 1809 is coupled to a portion of screw 1807 below bottom clamp bar 1805 (e.g., below the clamping interface of bottom clamp bar 1805). The exterior surface of pivot nut 1809 facing bottom clamp bar 1805 has a rounded shape, such as a cylindrical shape or a barrel shape. Bottom clamp bar 1805 may include indent 1825 (also referred to as a socket or recess) shaped to receive a portion of pivot nut 1809, which helps pivot nut 1809 rotate about an axis parallel to the y-axis. For example, indent 1825 includes a rounded surface that receives the rounded exterior surface of pivot nut 1809.

As previously described, pivot nut 1809 is coupled to a portion of screw 1807 below bottom clamp bar 1805. During opening or closing of clamp 1801, screw 1807 translates relative to pivot nut 1809. An end nut 1847 is coupled to the end of screw 1807 and configured to prevent screw 1807 from being further unscrewed when end nut 1847 contacts pivot nut 1809. Thus, end nut 1847 restricts movement of screw 1807 (e.g., compare the position of end nut 1847 relative to pivot nut 1809 in FIGS. 18E and 18F), which also affects the maximum distance between top clamp bar 1803 and bottom clamp bar 1805 in the clamp's open position. Among other advantages, end nut 1847 prevents screw 1807 from being unscrewed past a threshold, thus preventing screw 1807 and top clamp bar 1803 from being unintentionally released from clamp 1801 during operation (e.g., if screw 1807 were unscrewed too much).

Clamp 1801 includes pivot pin 1811. Pivot pin 1811 is a cylindrical pin arranged to engage with a side of pivot nut 1809 (however other pin shapes are possible). Pivot pin 1811 may help hold pivot nut 1809 in place near the bottom clamp bar 1805 (e.g., in indent 1825), while allowing pivot nut 1809 to rotate about an axis parallel to the y-axis. Thus pivot pin 1811 engaged with pivot nut 1809 may form a “first” pivot point which allows screw 1807 (and top clamp bar 1803) to tilt forward when clamp 1801 is closed and tilt backward when clamp 1801 is opened. In the example of FIG. 18, an end of pivot pin 1811 rests in an indent 1815 of pivot nut 1809 and engages with sides of pivot nut 1809 formed by indent 1815 to help pivot nut 1809 rotate about an axis parallel to the y-axis. Said differently, pivot nut 1809 includes a rounded wall 1813 that extends outward (in the −y direction), and the end of pivot pin 1811 is positioned to engage with the inner side of wall 1813 to form the pivot point. Clamp 1801 additionally includes a second pivot pin with an end that rests in an indent on the opposite side of pivot nut 1809 (the second pivot pin and indent are not labeled in FIG. 18). Having pivot pins engaged with opposite ends of pivot nut 1809 may help hold pivot nut 1809 in place and help stabilize rotation of pivot nut 1809 during operation. In some embodiments, a second end of the second pivot pin engages with a pivot nut of an adjacent clamp (e.g., see FIG. 18G).

In some embodiments, bottom clamp bar 1805 includes pin indent 1819 (also referred to as a recess) configured to receive at least a portion of pivot pin 1811, which may help installation of pivot pin 1811 and may help hold pivot pin 1811 in place during operation (e.g., in addition to any other fastening mechanisms, such as screws). In the example of FIG. 18, pivot pin 1811 is directly coupled to a bottom surface of bottom clamp bar 1805 (e.g., pivot pin 1811 rests in pin indent 1819). However, this is not required. For example, pivot pin 1811 is held in place by being coupled to another surface or structure (e.g., it is coupled to wall 1843).

As previously described, screw 1807 passes through hole 1827 in top clamp bar 1803 and hole 1828 in bottom clamp bar 1805. Hole 1828 may be large enough to allow screw 1807 to tilt (e.g., when clamp 1801 is opened or closed during operation), which increases the clearance for loading and unloading an object in the clamp. For example, hole 1828 has an oblong shape (e.g., hole 1828 is a slot), with the long axis being in the rotation direction of screw 1807 about the first pivot point. Similarly, hole 1827 may be large enough to allow top clamp bar 1803 to pivot (e.g., by a few degrees) relative to screw 1807 (and bottom clamp bar 1805), which also increases the clearance for loading and unloading an object in the clamp For example, hole 1827 has an oblong shape (e.g., hole 1827 is a slot) with the long axis being in the rotation direction of screw 1807 about the first pivot point (or in the rotation direction of top clamp bar 1803 about the second pivot point as further described below).

Pivot pin 1817 is a cylindrical pin (however other pin shapes are possible). In the perspective of FIGS. 18E and 18F, pivot pin 1817 is coupled to the bottom surface of top clamp bar 1803. Pivot pin 1817 may form a “second” pivot point that (e.g., in conjunction with hole 1827 being larger than the diameter of screw 1807 as previously described) allows top clamp bar 1803 to rotate relative to screw 1807 (and bottom clamp bar 1805). More specifically, due to the position of pivot pin 1817 relative to bottom clamp bar 1805 and top clamp bar 1803, top clamp bar 1803 may rotate toward or away from the top surface of bottom clamp bar 1805 about an axis parallel to the y-axis (this rotation may be in addition to, or alternative to, rotation about the first pivot point formed by pivot pin 1811 and pivot nut 1809).

In the perspective of FIGS. 18E-18F, pivot pin 1817 may rest on the top surface of bottom clamp bar 1805 while clamp 1801 is in a closed position (e.g., FIG. 18F). As clamp 1801 is opened (e.g., by unscrewing screw 1807), pivot pin 1817 moves along the top surface due to rotation of screw 1807 about the first pivot point. If clamp 1801 is opened wide enough, pivot pin 1817 can move off the back edge of bottom clamp bar 1805 and rest on a side of wall 1843 (e.g., see FIG. 18E). Among other advantages, movement of pivot pin 1817 off the edge, may enable clamp 1801 to open further (as opposed to keeping pivot pin 1817 on the top surface of bottom clamp bar 1805).

Top clamp bar 1803 (or bottom clamp bar 1805) may include a pin indent 1821 (also referred to as a recess) configured to receive at least a portion of pivot pin 1811, which may help installation of pivot pin 1811 and may help hold pivot pin 1811 in place during operation (e.g., in addition to any other fastening mechanisms, such as screws).

In the perspective of FIGS. 18E-18F, clamp 1801 includes washer 1837 on a portion of screw 1807 above top clamp bar 1803 (e.g., above the surface configured to interface with an object). Washer 1837 includes a rounded surface (e.g., a cylindrical surface or a barrel-shaped surface) that faces the top surface of top clamp bar 1803. Top clamp bar 1803 includes a rounded indent 1839 configured to receive at least part of washer 1837, which may facilitate movement (e.g., rotation) of top clamp bar 1803 relative to screw 1807.

As previously described, screw 1807 (and top clamp bar 1803) can rotate about the first pivot point as clamp 1801 is opened (e.g., by unscrewing screw 1807). This rotation may be due to spring 1823 applying a force to rotate screw 1807. Spring 1823 is coupled to ends of shoulder screw 1830 and shoulder screw 1831. Spring 1823 applies a force to bring the ends of the shoulder screws together. Shoulder screw 1830 is coupled to and extends away from a back side of top clamp bar 1803 (e.g., see FIGS. 18E and 18F). Shoulder screw 1830 can act as a lever to rotate top clamp bar 1803 about the first pivot point. Shoulder screw 1831 is coupled to and extends away from wall 1843 (in other words shoulder screw 1831 extends in the +x-direction). Although a helical spring is illustrated in the example of FIG. 18, other types of springs and other types of force applicator mechanisms may be used apply a force to move screw 1807 about the first pivot point and/or to bring ends of the shoulder screws together.

In some embodiments, a clamp (e.g., 1801) includes teeth to increase the hold of the object. For example, clamp 1801 includes serrated teeth 1829. Teeth 1829 may be a ˜1 millimeter insert and may be installed in a recess in bottom clamp bar 1805 (recess is not labeled in FIG. 18). The material, shape, and structure of serrated teeth 1829 may depend on the types of objects to be held. For example, serrated teeth 1829 is configured to hold an edge of sheet metal and is made of tungsten carbide.

Vertical clamping system 1800 includes coupling elements 1841A and 1841B on sides of bottom clamp bar 1805. Coupling elements 1841A, 1841B enable vertical clamping system 1800 to be coupled to (e.g., mounted to) a frame or another horizontal or vertical clamping system (e.g., via bolts or screws).

### 9.4 Additional Example Vertical Clamping Systems

Additional example embodiments of clamping systems are described below. Although references are made to vertical clamping system 1800 in the below descriptions, the example embodiments described below are not required to include the components or features previously described with respect to vertical clamping system 1800.

Some aspects relate to a mechanical clamping system (e.g., vertical clamping system 1800) configured to hold an object (e.g., 110, 520, 700, 910, 1015), the mechanical clamping system including: a bottom clamp bar (e.g., bottom clamp bar 1805) with a top surface configured to interface with the object to be held; a top clamp bar (e.g., top clamp bar 1803) with a bottom surface configured to interface with the object to be held; a screw (e.g., screw 1807) that passes through a first hole (e.g., hole 1827) in the top clamp bar and a second hole (e.g., hole 1828) in the bottom clamp bar; a pivoting nut (e.g., pivot nut 1809) coupled to a portion of the screw below the top surface of the bottom clamp bar; and a pivoting pin (e.g., pivot pin 1811) arranged below the top surface of the bottom clamp bar and engaged with a side of the pivoting nut to form a pivot point enabling the screw to pivot about the pivot point.

In some aspects, the pivoting nut includes a curved wall (e.g., wall 1813) and an end of the pivoting pin engages with the curved wall to form the pivot point.

In some aspects, a surface of the pivoting nut includes an indentation (e.g., indent 1815) and an end of the pivoting pin engages with the indentation to form the pivot point. For example, the end of the pivoting pin rests in the indentation and the pivot point is formed by the end of the pivoting pin contacting a side of the indentation.

In some aspects, the pivoting pin is coupled to a bottom surface of the bottom clamp bar (e.g., see FIG. 18G) e.g., via one or more screws.

In some aspects, the pivoting pin (e.g., pivot pin 1811) at least partially rests in an indentation (e.g., pin indent 1819) of the bottom surface of the bottom clamp bar.

In some aspects, a bottom surface of the bottom clamp bar includes an indentation (e.g., indent 1825) shaped to receive at least a portion of the pivoting nut. Due to this, the pivoting nut can rest in the indentation. The indentation may have a cylindrical or barrel shaped recess to receive (e.g., to match) the exterior surface of the pivoting nut (e.g., in embodiments where the pivoting nut has a cylindrical or barrel-shaped exterior surface shape).

In some aspects, the top clamp bar includes a rounded edge (e.g., rounded edge 1733) configured to interface with the object to be held. Among other advantages, the rounded edge enables the mechanical clamping system to hold objects of different thicknesses.

In some aspects, the mechanical clamping system further includes a second pivot pin (e.g., pivot pin 1817) coupled to a rear portion of the bottom surface of the top clamp bar, the second pivot pin configured to (e.g., when in contact with the top surface of the bottom clamp bar) form a second pivot point for the top clamp bar (e.g., see FIGS. 18E-F).

In some aspects, the bottom surface of the top clamp bar includes an indentation (e.g., pin indent 1819) shaped to receive at least a portion of the second pivot pin (e.g., pivot pin 1817). Due to this, the second pivot pin can rest in the indentation. The indentation may have a cylindrical shaped recess to receive (e.g., to match) the exterior surface of the second pivot pin (e.g., in embodiments where the second pivot pin has a cylindrical exterior surface shape).

In some aspects, the mechanical clamping system, further includes a spring (e.g., spring 1823) coupled to the top clamp bar and the bottom clamp bar, the spring applying a force to rotate the screw about the pivot point (e.g., pivot point formed by pivot pin 1811 and/or pivot point formed by pivot pin 1817). The spring is applying a force to move the top clam bar 1803 into an open position. In the example of FIG. 18F, the spring 1823 is applying a force to rotate the top clamp bar 1803 counter clockwise. Thus, when the screw 1807 is moved upward (e.g., unscrewed), the top clamp bar 1803 the top clamp bar 1803 tilts away from the top surface of the bottom clamp bar 1805 (FIG. 18E illustrates the top clamp bar 1803 tilted backward).

In some embodiments, a first end of the spring is coupled to a first shoulder screw which is coupled to and protruding from a backside of the top clamp bar, and a second end of the spring is coupled to a second shoulder screw that is coupled to the bottom clamp bar (e.g., directly coupled to the bottom clamp bar or coupled to a rear wall which is coupled to the bottom clamp bar (e.g., see FIG. 18).

Other aspects include components, devices, systems, improvements, methods, processes, applications, computer readable mediums, and other technologies related to any of the above.

### 10. Example Machine Architecture

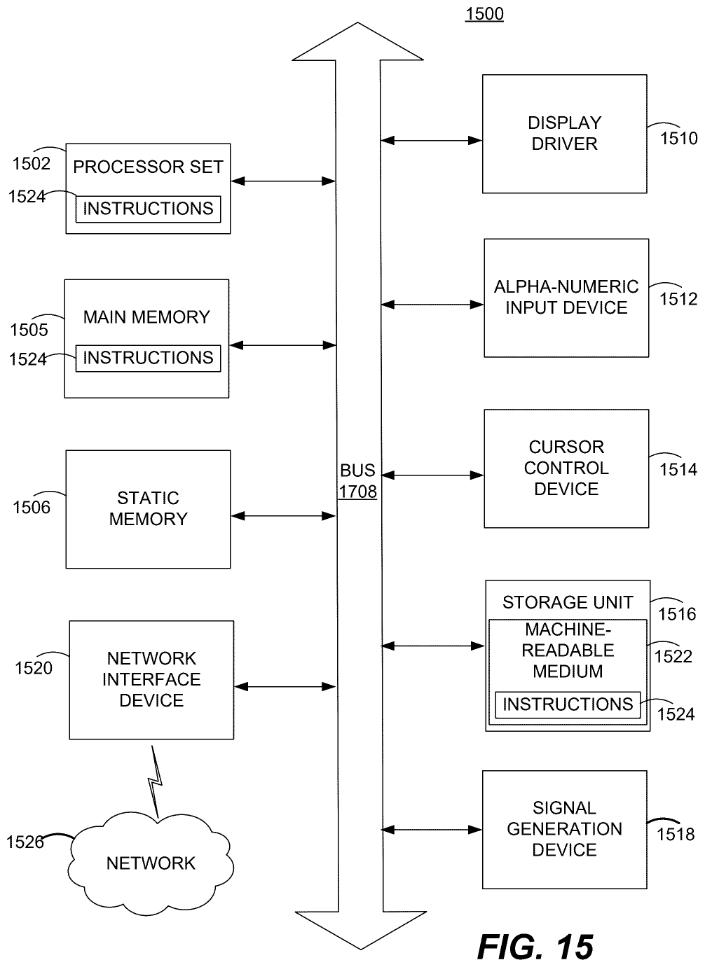

In some embodiments, the controller (e.g., controller 255 or controller 1120) is a machine able to read instructions from a machine-readable medium and execute them in a set of one or more processors. FIG. 15 is a block diagram illustrating components of an example machine able to read instructions from a machine-readable medium and execute them in a set of one or more processors. Specifically, FIG. 15 shows a diagrammatic representation of a machine in the example form of a computer system 1500. The computer system 1500 can be used to execute instructions 1524 (e.g., program code or software) for causing the machine to perform any one or more of the methodologies (or processes) described herein. In alternative embodiments, the machine operates as a standalone device or a coupled (e.g., networked) device that connects to other machines. In a networked deployment, the machine may operate in the capacity of a server machine or a client machine in a server-client network environment, or as a peer machine in a peer-to-peer (or distributed) network environment. Here, the robots, e.g., 400A, 400B, and other automated components may include all or a portion of the component of the described computer system (or machine) 1500. The robots, e.g., 400A, 400B, and/or other automated components may be programmed with program code to operate as described with FIGS. 1-14B. Such operation also include program code corresponding to the disclosed models, e.g., 1400, 1415, for effecting the resulting geometries through the robots, e.g., 400A, 400B and other automated components.

The machine may be a server computer, a client computer, a personal computer (PC), a tablet PC, a smartphone, an internet of things (IoT) appliance, a network router, or any machine capable of executing instructions 1524 (sequential or otherwise) that specify actions to be taken by that machine. Further, while only a single machine is illustrated, the term “machine” shall also be taken to include any collection of machines that individually or jointly execute instructions 1524 to perform any one or more of the methodologies discussed herein.

The example computer system 1500 includes a set of one or more processing units 1502. The processor set 1502 is, for example, one or more central processing units (CPUs), one or more graphics processing units (GPUs), one or more digital signal processors (DSPs), one or more state machines, one or more application specific integrated circuits (ASICs), one or more radio-frequency integrated circuits (RFICs), or any combination of these. If the processor set 1502 include multiple processors, the processors may operate individually or collectively. The processor set 1502 also may be a controller. The controller may include a non-transitory computer readable storage medium that may store program code to operate (or control) the robots, e.g., 400A, 400B, and/or other automated components described herein.

For convenience, the processor 1502 is referred to as a single entity but it should be understood that the corresponding functionality may be distributed among multiple processors using various ways, including using multi-core processors, assigning certain operations to specialized processors (e.g., graphics processing units), and dividing operations across a distributed computing environment. Any reference to a processor 1502 should be construed to include such architectures.

The computer system 1500 also includes a main memory 1504. The computer system may include a storage unit 1516. The processor 1502, memory 1504 and the storage unit 1516 communicate via a bus 1508.

In addition, the computer system 1500 can include a static memory 1506, a display driver 1510 (e.g., to drive a plasma display panel (PDP), a liquid crystal display (LCD), or a projector). The computer system 1500 may also include alphanumeric input device 1512 (e.g., a keyboard), a cursor control device 1514 (e.g., a mouse, a trackball, a joystick, a motion sensor, or other pointing instrument), a signal generation device 1518 (e.g., a speaker), and a network interface device 1520, which also are configured to communicate via the bus 1508.

The storage unit 1516 includes a machine-readable medium 1522 on which is stored instructions 1524 (e.g., software) embodying any one or more of the methodologies or functions described herein. The instructions 1524 may also reside, completely or at least partially, within the main memory 1504 or within the processor 1502 (e.g., within a processor's cache memory) during execution thereof by the computer system 1500, the main memory 1504 and the processor 1502 also constituting machine-readable media. The instructions 1524 may be transmitted or received over a network 1526 via the network interface device 1520.

While machine-readable medium 1522 is shown in an example embodiment to be a single medium, the term “machine-readable medium” should be taken to include a single medium or multiple media (e.g., a centralized or distributed database, or associated caches and servers) able to store the instructions 1524. The term “machine-readable medium” shall also be taken to include any medium that is capable of storing instructions 1524 for execution by the machine and that cause the machine to perform any one or more of the methodologies disclosed herein. The term “machine-readable medium” includes, but not be limited to, data repositories in the form of solid-state memories, optical media, and magnetic media.

While machine-readable medium 722 (also referred to as a computer-readable storage medium) is shown in an embodiment to be a single medium, the term “machine-readable medium” should be taken to include a single medium or multiple media (e.g., a centralized or distributed database, or associated caches and servers) able to store the instructions 724. The term “machine-readable medium” shall also be taken to include any medium that is capable of storing instructions 724 for execution by the machine and that cause the machine to perform any one or more of the methodologies disclosed herein. The term “machine-readable medium” shall also be taken to be a non-transitory machine-readable medium. The term “machine-readable medium” includes, but not be limited to, data repositories in the form of solid-state memories, optical media, and magnetic media.

### 11. Additional Considerations

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. In some cases, a module can be implemented in hardware, firmware, or software.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments. This is done for convenience and to give a general sense of the disclosure. This description should be read to include one or at least one and the singular also includes the plural unless it is obvious that it is meant otherwise. Where values are described as “approximate” or “substantially” (or their derivatives), such values should be construed as accurate +/−10% unless another meaning is apparent from the context. From example, “approximately ten” should be understood to mean “in a range from nine to eleven.”

Upon reading this disclosure, those of skill in the art will appreciate still additional alternative structural and functional designs. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed. The scope of protection should be limited only by any claims that issue.

What is claimed is:

1. A mechanical clamping system, the mechanical clamping system comprising:
a bottom clamp bar with holes and a top surface configured to interface with an object to be held;
top clamp bars adjacent to each other and arranged along a portion of the bottom clamp bar, the top clamp bars having bottom surfaces configured to interface with the object to be held, the top clamp bars coupled with the bottom clamp bar through fastening members passing between respective holes of the top clamp bars and the holes of the bottom clamp bar; and
pins coupled to bottom surfaces of the top clamp bars or top surfaces of the bottom clamp bar, the pins forming pivot points for bottom surfaces of the top clamp bars to pivot toward or away from the top surface of the bottom clamp bar.

2. The mechanical clamping system of claim 1, further comprising retaining rings coupled to portions of the fastening members between the top surface of the bottom clamp bar and the bottom surfaces of the top clamp bars.

3. The mechanical clamping system of claim 2, wherein the retaining rings are positioned on the fastening members to push the bottom surfaces of the top clamp bars to pivot away from the top surface of the bottom clamp bar responsive to the fastening members being moved upward.

4. The mechanical clamping system of claim 1, wherein the top clamp bars include rounded edges configured to interface with objects that have a range of thicknesses.

5. The mechanical clamping system of claim 1, wherein pivot axes of the pivot points are parallel to each other.

6. The mechanical clamping system of claim 1, wherein pivot axes of the pivot points are aligned with each other.

7. The mechanical clamping system of claim 1, wherein the holes in the top clamp bars are oblong in directions perpendicular to pivot axes of the pivot points.

8. The mechanical clamping system of claim 1, further comprising: washers on portions of the fastening members above the bottom surfaces of the top clamp bars, the washers including rounded surfaces facing the top clamp bars.

9. The mechanical clamping system of claim 8, wherein top surfaces of the top clamp bars include indentations shaped to receive the rounded surfaces of the washers.

10. The mechanical clamping system of claim 1, further comprising coupling elements coupled to opposite ends of the bottom clamp bar, the coupling elements configured to mount the bottom clamp bar to a frame.

11. The mechanical clamping system of claim 1, wherein bottom surfaces of the top clamp bars include indentations shaped to receive at least portions of the pins.

12. The mechanical clamping system of claim 1, wherein the pins are coupled to rear portions of the bottom surfaces of the top clamp bars.

13. A mechanical clamping system, the mechanical clamping system comprising:
a bottom clamp bar with a hole and a top surface configured to interface with an object to be held;
a top clamp bar arranged on a portion of the bottom clamp bar, the top clamp bar having a bottom surface configured to interface with the object to be held, the top clamp bar coupled with the bottom clamp bar through a fastening member passing between a hole of the top clamp bar and the hole of the bottom clamp bar; and
a pin coupled to the bottom surface of the top clamp bar or the top surface of the bottom clamp bar, the pin forming a pivot point for the bottom surface of the top clamp bar to pivot toward or away from the top surface of the bottom clamp bar.

14. The mechanical clamping system of claim 13, further comprising a retaining ring coupled to a portion of the fastening member between the top surface of the bottom clamp bar and the bottom surface of the top clamp bar.

15. The mechanical clamping system of claim 14, wherein the retaining ring is positioned on the fastening member to push the bottom surface of the top clamp bar to pivot away from the top surface of the bottom clamp bar responsive to the fastening member being moved upward.

16. The mechanical clamping system of claim 13, wherein the top clamp bar includes a rounded edge configured to interface with objects that have a range of thicknesses.

17. The mechanical clamping system of claim 13, wherein the hole in the top clamp bar is oblong in a direction perpendicular to pivot axis of the pivot point.

18. The mechanical clamping system of claim 13, further comprising: a washer on a portion of the fastening member above the bottom surface of the top clamp bar, the washer including a rounded surface facing the top clamp bar.

19. The mechanical clamping system of claim 18, wherein the top surface of the top clamp bar includes an indentation shaped to receive the rounded surface of the washer.

20. The mechanical clamping system of claim 13, further comprising coupling elements coupled to opposite ends of the bottom clamp bar, the coupling elements configured to mount the bottom clamp bar to a frame.
